(19) United States
(12) Patent Application Publication
(10) Pub. No.: US 2026/0289852 A1
(43) Pub. Date: Sep. 24, 2026

(54) SYSTEM

(71) Applicant: SoftBank Group Corp., Tokyo (JP)

(72) Inventor: Saya FUJINO, Tokyo (JP)

(73) Assignee: SoftBank Group Corp., Tokyo (JP)

(21) Appl. No.: 19/558,690

(22) Filed: Mar. 6, 2026

(30) Foreign Application Priority Data
Mar. 19, 2025 (JP) 2025-044523

(51) Int. Cl. G06T 11/60; G06T 7/11; G06V 40/16

(52) U.S. Cl. CPC G06T 11/60; G06T 7/11; G06V 40/165; G06T 2207/20084

(57) ABSTRACT

A system includes a processor that is configured to receive input information from a user, search a database for related clothing information in order to propose clothing that matches a corresponding image indicated by the input information, analyze a face image of the user to extract facial features and propose makeup suitable for the clothing based on the extracted facial features, and generate a prompt sentence that instructs a generative AI model to generate a style proposal based on the input information from the user.

### CROSS-REFERENCE TO RELATED APPLICATION

This application is based on and claims priority under 35 USC 119 from Japanese Patent Application No. 2025-044523 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional fashion coordination systems and cosmetic recommendation systems tend to handle clothing selection and makeup suggestion as independent processes, and therefore often fail to provide a coherent style proposal that consistently reflects a user's desired image across clothing, makeup, and product selection. Existing systems also generally rely on fixed rule-based logic or manually prepared style catalogs, and do not sufficiently utilize generative artificial intelligence models to flexibly generate style proposals tailored to individual user preferences. As a result, users must separately search for clothing, makeup, and related products, which is time-consuming and may lead to inconsistent overall styling that does not accurately match the user's intended image.

### SUMMARY

In order to solve the foregoing problems, the present invention provides a system comprising a processor, wherein the processor is configured to receive input information from a user, and to search a database for related clothing information in order to propose clothing that matches a corresponding image indicated by the input information. The processor is further configured to analyze a face image of the user to extract facial features, and to propose makeup suitable for the clothing based on the extracted facial features, thereby enabling coordinated styling of both clothing and makeup in accordance with the user's desired image. In addition, the processor is configured to generate a prompt sentence that instructs a generative AI model to generate a style proposal based on the input information from the user, so that a flexible and highly personalized style suggestion can be produced by the generative AI model. The processor may also recommend products or items suitable for an image selected by the user, based on the selected image, thus allowing the user to seamlessly obtain clothing, makeup, and related products consistent with the proposed style.

The term “system” refers to an arrangement of hardware and software components, including at least one processor and associated memory and storage, configured to execute the functions described in the claims.

The term “processor” refers to one or more hardware processing units, such as a central processing unit (CPU), graphics processing unit (GPU), application-specific integrated circuit (ASIC), or system-on-chip (SoC), which execute instructions to perform the operations described in the claims.

The term “input information” refers to data provided by a user to the system, including but not limited to style preferences, desired images, brand names, celebrity names, or other parameters indicative of a fashion or styling intention.

The term “image” refers to a conceptual representation or stylistic impression desired by the user, including, for example, fashion styles such as cute, elegant, or mode, and styles associated with particular brands, celebrities, or aesthetic categories.

The term “clothing information” refers to data stored in a database regarding clothing items, including at least item type, style category, brand, size, color, price, and purchase-related information.

The term “face image” refers to an image, such as a photograph or video frame, in which at least a portion of a user's face is visible and suitable for analysis of facial features.

The term “facial features” refers to characteristics of a user's face that can be derived from a face image, including but not limited to eye shape, skin tone, face shape, eyebrow shape, lip shape, and other morphological or color attributes relevant to makeup or styling.

The term “makeup” refers to cosmetic products and their application methods used to enhance or modify the appearance of a user's face, including foundation, concealer, blush, eyeshadow, eyeliner, mascara, eyebrow products, and lip products.

The term “makeup proposal” refers to a recommendation generated by the system that specifies one or more cosmetic products, color selections, and application methods suitable for the user, particularly in relation to the proposed clothing or style.

The term “prompt sentence” refers to a text string or structured textual instruction generated by the processor and provided to a generative AI model to specify conditions, constraints, or objectives for generating a style proposal.

The term “generative AI model” refers to a machine learning model, such as a generative language model or multimodal model, that is trained to generate outputs including text or other content based on input prompts or conditions.

The term “style proposal” refers to a system-generated recommendation describing a coordinated fashion style, including at least clothing combinations and optionally corresponding makeup and accessory suggestions, consistent with the user's desired image.

The term “products or items” refers to tangible or digital goods related to fashion and styling, including clothing, shoes, accessories, cosmetics, and related merchandise that can be recommended and optionally purchased by the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

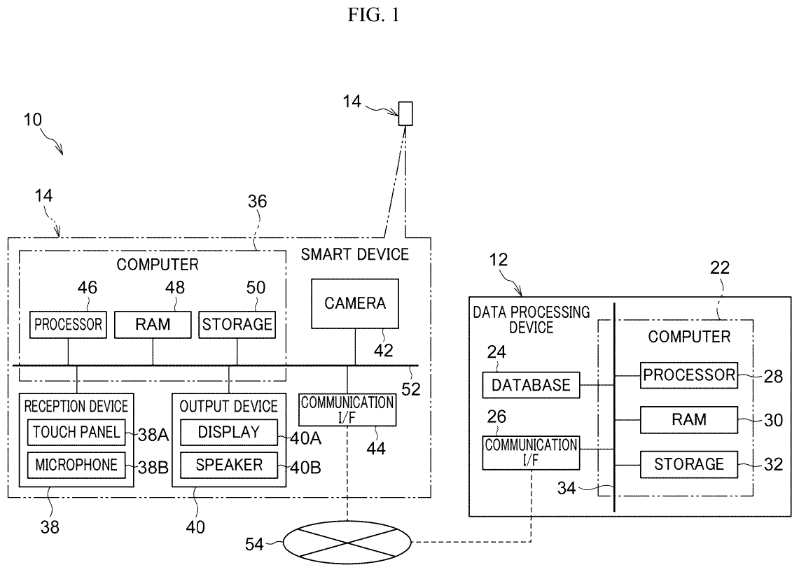

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

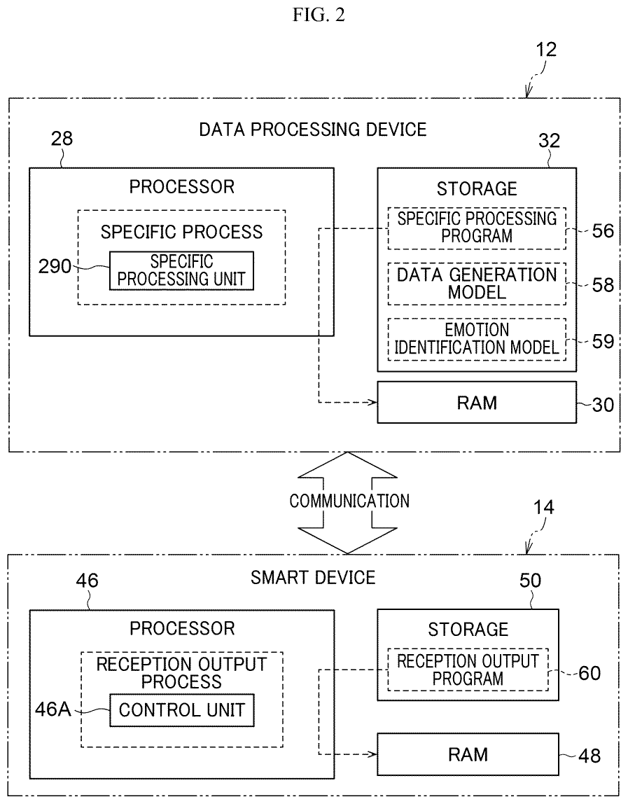

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional style recommendation systems and cosmetic advisory systems typically employ fixed rule sets or simple content filtering logic to match user inputs with pre-defined style templates or product lists. In such systems, a server generally retrieves item records from a database based solely on keywords, categories, or static user profiles, and outputs recommendations without deeply integrating visual characteristics of the user or dynamically generating new style concepts. As a result, these systems are limited in their ability to generate coherent, individualized combinations of fashion and makeup that are contextually aligned with both a user's style preferences and facial features.

Further, known systems that incorporate machine learning or generative models often use such models in an isolated manner, for example, by invoking a generative model with a generic prompt and returning the raw output to a client device. These approaches typically do not employ a structured, iterative prompt design process in which user preference information is normalized into higher-level style attributes, combined with facial feature data, and then fed back into a generative AI model in multiple stages. Consequently, the resulting outputs can be inconsistent, difficult to structure, and inefficient to render on resource-constrained terminals.

Additionally, conventional systems inadequately support interactive refinement based on user feedback. Even when a user provides additional constraints, such as making a style more casual or adjusting makeup intensity, existing architectures generally apply simple filters or re-ranking heuristics to pre-existing recommendations. They do not regenerate style and makeup proposals by systematically updating prompt sentences and re-invoking a generative AI model under refined conditions. This leads to suboptimal reuse of computational resources, fragmented data representations, and limited personalization.

From a computer-technology perspective, there is a need for an improved server-side processing architecture that: (i) unifies text-based preference analysis and image-based facial feature extraction into a common data representation, (ii) transforms heterogeneous user inputs into well-structured prompt sentences for a generative AI model in multiple stages, (iii) stores and associates the generated style and makeup information as structured data suitable for efficient retrieval and presentation, and (iv) supports iterative, feedback-driven regeneration with explicit update prompt sentences. Without such an architecture, the computing system is unable to efficiently orchestrate complex interactions between user inputs, generative AI processing, and terminal presentation, resulting in higher computational overhead, less reliable outputs, and degraded user experience.

The specific processing by the specific processing unit 290 of the data processing device 12 in Example 1 is realized by the following means.

The present invention provides a server comprising a processor configured to acquire user preference information and a face image from a communication terminal, normalize image-related preference information into higher-level style attributes, generate and transmit structured prompt sentences to a generative AI model to obtain style proposal information, perform image preprocessing and feature extraction on the face image to derive facial feature data, generate makeup method proposal information based on both the style proposal information and the facial feature data, store and associate the style proposal information and the makeup method proposal information as structured data, and further acquire user feedback conditions via the communication terminal in order to generate updated prompt sentences and obtain refined style and makeup proposals from the generative AI model. This enables a computer-implemented system to more efficiently and coherently orchestrate text-based preference analysis, image-based feature computation, and generative AI processing, thereby improving the technical operation of the server in generating, structuring, and iteratively refining personalized fashion and makeup proposals for presentation on a communication terminal.

The term “system” refers to a combination of one or more computing devices, storage devices, and communication interfaces that cooperatively execute programmed instructions to perform the functions described herein.

The term “processor” refers to one or more hardware processing units, such as a central processing unit, a graphics processing unit, or a dedicated accelerator, that execute machine-readable instructions to perform arithmetic, logical, control, and input/output operations.

The term “communication terminal” refers to an electronic device operated by a user, such as a mobile device, a tablet device, a personal computer, or any other network-capable device, that exchanges data with the server and presents information to the user.

The term “user preference information” refers to data received from the communication terminal that represents a user's stylistic choices, desired images, admired items, or other selection inputs, including but not limited to style labels, product references, and descriptive text.

The term “face image” refers to digital image data representing at least a portion of a user's face, captured or selected at the communication terminal and transmitted to the server for analysis.

The term “image information” refers to data elements included in the user preference information that describe or represent visual styles, images, or stylistic concepts, including explicit style labels and implicit style-related descriptors.

The term “higher-level category” refers to an abstract style class or generalized classification that groups multiple specific styles, items, or descriptors into a broader style attribute.

The term “style attribute” refers to a categorized representation of a user's stylistic preference, derived by normalizing and classifying the user preference information into one or more generalized style categories.

The term “prompt sentence” refers to a machine-readable text string generated by the processor that instructs a generative AI model to perform a specified generation task, including generating style proposals or recommendation target information.

The term “generative AI model” refers to a machine learning model configured to generate output data, such as text or other content, in response to an input prompt sentence, by probabilistic or learned transformation of the input.

The term “style proposal” refers to a generated concept of a coordinated appearance, including clothing, accessories, or other stylistic elements, that corresponds to a determined style attribute and user preference information.

The term “style proposal information” refers to structured or unstructured data representing one or more style proposals generated by the generative AI model based on a prompt sentence.

The term “image preprocessing” refers to operations performed on the face image before feature extraction, including at least one of resizing, normalization, color space conversion, cropping, and noise reduction.

The term “feature extraction processing” refers to computational operations applied to the preprocessed face image to derive numerical or categorical data representing facial characteristics, including shape features and color features.

The term “feature data” refers to data representing characteristics extracted from the face image, including coordinates, descriptors, or categorical labels associated with facial regions, shapes, and color distributions.

The term “shape features” refers to data describing geometric characteristics of the face, including but not limited to face contour, eye shape, lip shape, and relative positions of facial components.

The term “color features” refers to data describing chromatic characteristics of the face, including but not limited to skin tone, undertone, and color distributions in specific facial regions.

The term “makeup method proposal information” refers to data representing recommended cosmetic application methods, product types, colors, or application steps that are generated based on style proposal information and facial feature data.

The term “structured data” refers to data that is organized into a defined format, such as key-value pairs, records, or hierarchical objects, enabling efficient storage, retrieval, and association of style proposal information and makeup method proposal information.

The term “response data” refers to data transmitted from the server to the communication terminal that includes at least the style proposal information and the makeup method proposal information, formatted for presentation or further processing at the communication terminal.

The term “additional conditions” refers to refinement information or constraints received from the user, such as changes in formality, budget, intensity, or other style-related parameters, that are used to update prompt sentences and regenerate proposals.

The term “update prompt sentence” refers to a prompt sentence generated by the processor that incorporates additional conditions or refined constraints, and that is input to the generative AI model to obtain updated style proposal information and updated makeup method proposal information.

The term “facial region” refers to a defined portion of the face, such as an eye region, lip region, cheek region, or brow region, identified using facial feature data extracted from the face image.

The term “recommendation target information” refers to data representing items or categories that can be recommended to the user, including at least one category other than clothing, such as cosmetic items, accessories, or related goods or services.

In one embodiment, a server executes a set of machine-readable instructions on a processor to implement a style recommendation and cosmetic guidance system in cooperation with a terminal operated by a user. The server includes at least one central processing unit, at least one graphics processing unit, a main memory, a non-volatile storage device such as a solid-state drive, and one or more network interfaces. The server executes an operating system such as a general-purpose server operating system, and an application stack including a web framework (for example, a framework equivalent to a typical application framework), a database management system (for example, a relational database management system), an image processing library (for example, a library equivalent to a generic computer vision library), and a machine learning framework (for example, a framework equivalent to a deep learning framework).

The terminal includes at least one processor, a display, a user input interface such as a touchscreen, a camera module, a memory, and a communication interface. The terminal executes a client application implemented as a native application or a web application. The user operates the terminal to input preference information and a face image, and to view style proposal information and makeup method proposal information.

The server uses the database management system to store multiple tables or collections, including at least a request table, a style proposal table, a face feature table, and a makeup proposal table. The server assigns a unique request identifier to each received user request and uses this identifier as a key to associate records across these data structures. Each record in the style proposal table stores, as structured data, fields such as a style attribute, textual description of coordinated items, and links to recommendation target information. Each record in the face feature table stores, as structured data, numerical vectors representing facial geometry and color distributions, as well as categorical labels such as eye shape, face shape, and skin undertone.

The server uses the image processing library and the machine learning framework to perform image preprocessing and feature extraction on the face image. The server decodes the image into a two-dimensional or three-dimensional tensor representation in main memory, converts the image to a standard color space, and normalizes intensity values. The server then uses a neural network model for facial landmark detection implemented as a deep convolutional network or as a transformer-based vision model. In one embodiment, the neural network includes multiple convolutional layers for feature extraction, pooling layers, and fully connected layers that output coordinates of facial landmarks. The server executes this network on the graphics processing unit to reduce computation time and increase throughput, and uses the machine learning framework to schedule matrix multiplication operations and activation functions.

The server derives shape features by computing relative distances and angles between the facial landmarks. For example, the server computes an eye aspect ratio, a lip height-to-width ratio, and a jawline curvature index. The server uses predetermined thresholds or a secondary classification neural network to map these continuous values into categorical labels, such as “almond-shaped eyes,” “thin lips,” or “oval face.” The server also extracts color features by sampling pixel values within skin regions segmented using the landmark coordinates. The server computes statistics such as mean and variance in a chosen color space and compares these values against stored ranges to classify skin tone and undertone as “warm,” “cool,” or “neutral.” By normalizing these features into low-dimensional vectors and discrete labels, the server reduces memory usage and improves the efficiency of subsequent matching and prompt generation.

The server uses a natural language processing module implemented on the processor to normalize user preference information into higher-level style attributes. The server receives, from the terminal, free-form text describing admired items or public figures, and discrete selections of style options. The server tokenizes the text, removes stop words, and applies synonym mapping using a predefined mapping table stored in the database. The mapping table groups various detailed expressions into generalized style categories, thereby reducing sparsity in the data and improving consistency of the generative AI model input. The server determines at least one style attribute representing a higher-level category, such as “elegant,” “cute,” or “mode,” and stores this attribute in association with the request identifier.

The server generates a prompt sentence for a generative AI model by combining the style attribute, user preference information, and optional contextual parameters such as an occasion or season. The server uses a template-based construction algorithm rather than simple concatenation. The server stores one or more parameterized templates in the database, each template specifying placeholders for style attributes, demographic information, and constraints. The server selects an appropriate template based on the style attribute and converts the template into a final prompt sentence by inserting normalized values. For example, the server generates a prompt sentence such as:

“You are a fashion stylist. Based on an elegant style and the mood described by the user, propose three coordinated outfits for a woman in her 20s attending a semi-formal evening event. Describe each outfit with specific clothing items, colors, materials, silhouettes, and accessories.”

In another example, the server generates a prompt sentence for combined fashion and makeup guidance such as:

“You are a professional makeup artist. The user will wear: a black silk dress with a fitted waist, a pearl necklace, nude pumps, and a small ivory clutch, in an elegant style. The user has warm undertone skin, almond-shaped eyes, medium-full lips, and an oval face shape. Propose a complete makeup look that matches this outfit. Describe foundation shade, contour, highlight, eye makeup (eyeshadow colors, eyeliner style, mascara), eyebrow styling, blush, and lip color. Provide step-by-step instructions.”

The generative AI model used by the server is implemented as a transformer-based neural network comprising an encoder-decoder or decoder-only architecture. The model includes multiple layers of self-attention mechanisms and feed-forward networks, with parameters representing learned embeddings and weight matrices. During training, the model minimizes a loss function such as cross-entropy between predicted token distributions and reference texts, and updates its weights by backpropagation using an optimization algorithm such as stochastic gradient descent with adaptive moments. Training data consists of large-scale corpora that include descriptions of clothing, style coordination, and cosmetic application instructions. The training process uses data augmentation techniques such as paraphrasing, synonym substitution, and color word expansion to improve robustness to varied inputs. At runtime, the server executes the generative AI model in inference mode. The server encodes the prompt sentence into token identifiers, maps them to embeddings, and passes the resulting sequences through the transformer layers on the graphics processing unit. The server sets generation parameters such as temperature and maximum token count to balance creativity and determinism. The server then decodes the generated tokens into text and returns the text as style proposal information or makeup method proposal information.

The server uses a post-processing module to parse the generated text into structured data. The post-processing module identifies list structures, item delimiters, and section headers within the generated text using pattern matching and language-specific heuristics. For example, when the generative AI model outputs:

“1) A black silk dress with a fitted waist, a pearl necklace, nude high-heeled shoes, and a small ivory clutch. 2) A cream-colored blouse with a high neckline, a navy pencil skirt, black shoes, and a simple metallic bracelet.”
the server recognizes the numbered list, splits the text at each number label, and extracts item descriptions into discrete fields. The server stores each outfit as a record containing elements such as a main garment, secondary garments, accessories, and footwear. This specific data structure enables the server to filter, sort, and retrieve proposals efficiently and to send only relevant subsets to the terminal, thereby reducing communication load.

In one embodiment, the server associates facial feature data with segments of the makeup method proposal information. The server uses the classification of facial regions (eyes, eyebrows, cheeks, lips) to segment the generated text. When the generative AI model outputs phrases such as “For the eyes,” “For the cheeks,” or “For the lips,” the server aligns these segments with region identifiers stored in the face feature table. The server then constructs response data containing a mapping between region identifiers and corresponding textual instructions. The terminal uses this mapping to overlay markers or instructions near the relevant regions on the user's face image on the display. This specific data organization improves user understanding and reduces cognitive load, providing a technical effect on the human-computer interface.

The server supports iterative refinement by generating update prompt sentences. When the user inputs additional conditions at the terminal, such as “make the style more casual,” “use lower-cost items,” or “reduce the intensity of eye makeup,” the server does not merely filter existing proposals. Instead, the server encodes the additional conditions into structured refinement parameters stored in association with the request identifier, and generates a new prompt sentence that references both the previous style proposal information and the refinement parameters. For example, the server may generate:

“Based on the previous elegant outfit proposals, generate three alternative outfits that are more casual and use lower-cost items while preserving the overall coordinated impression. Describe each outfit in detail.”

By re-invoking the generative AI model with update prompt sentences, the server obtains new proposals that consistently incorporate the refined constraints. This multi-stage prompt design yields a more coherent series of outputs than single-pass generation and reduces the need for manual post-filtering operations. Consequently, computational resources are used more effectively, and network bandwidth is reduced because unnecessary intermediate results are not repeatedly transmitted.

The server achieves technical improvements over conventional systems by integrating text-based normalization, image-based feature computation, and transformer-based generation into an orchestrated pipeline with specific data structures and control logic. The normalization of user preference information into higher-level style attributes reduces the dimensionality and redundancy of input space, which in turn reduces the number of tokens in the prompt sentence and shortens inference time on the generative AI model. The structured representation of facial features as compact numerical vectors and labels enables fast lookup and matching operations for multiple requests from the same user, reducing repeated computation. The association of style proposal information and makeup method proposal information as structured data in the database allows the server to cache and reuse parts of previous results, further decreasing processing latency.

The server also improves accuracy and consistency of proposals by enforcing a rule-based post-processing layer. The server compares generated outputs against a rule set specifying constraints such as color harmony patterns, face-shape-specific recommendations, and prohibited combinations. If the generated output violates one or more rules, the server automatically adjusts or discards the output and may generate an additional prompt sentence instructing the generative AI model to correct the identified problems. This hybrid use of statistical generation and deterministic constraints leads to reduced error rates and more reliable outcomes compared to purely human-driven or purely template-driven systems. The terminal benefits from reduced computation because heavy tasks such as image analysis and large-scale generation are performed on the server. The terminal primarily performs user interface rendering and light-weight image overlay processing. This division of labor allows the system to support terminals with limited processing capability while maintaining high-quality, real-time feedback.

The described embodiments are not limited to a specific network configuration or hardware vendor. The server can be implemented as a cluster of machines or as a virtualized instance in a cloud environment. The generative AI model can run on the same machine as the web application or on a separate inference server connected over a local network. The neural network used for face feature extraction can be replaced by other architectures such as graph-based models or attention-based models, provided that facial features are extracted into numerical and categorical representations.

The server can extend recommendation target information beyond clothing and cosmetics to include other product categories, such as accessories, grooming tools, or services. In this case, the server generates an additional prompt sentence instructing the generative AI model to propose items in broader categories consistent with the style attribute. For example, the server may generate:

“Based on the following elegant outfit and matching makeup look, propose suitable accessories and personal care items that enhance the overall style, including jewelry, bags, and grooming tools.”

By organizing the system in this manner, the server does not merely automate a human stylist's workflow. Instead, the server implements specific computational techniques and non-conventional data flows that improve processing speed, accuracy, and scalability. The cooperation between the terminal, the user, and the server, through structured prompt sentences, facial feature vectors, and rule-based post-processing, yields a technical solution that enhances the operation of the underlying computer system and provides a robust platform for generating and presenting personalized fashion and makeup proposals.

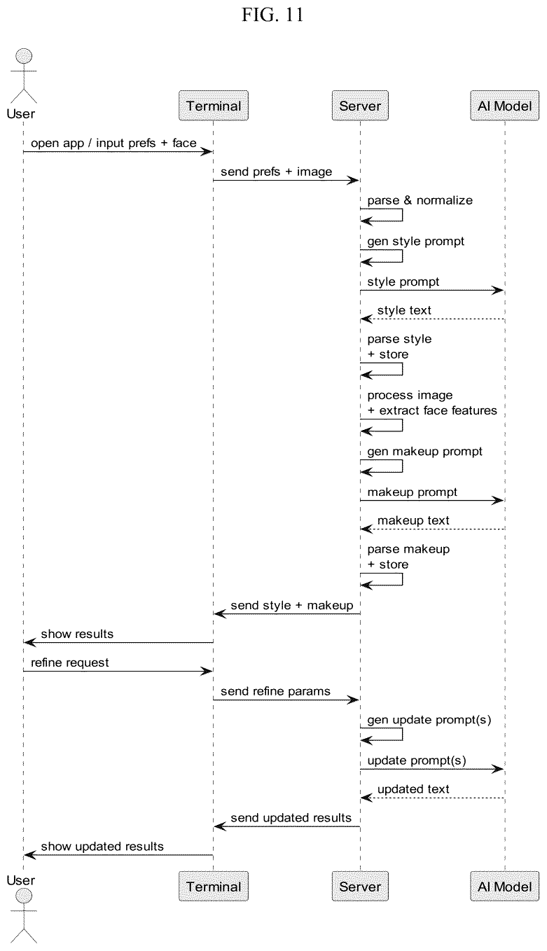

The following describes the processing flow using FIG. 11.

### Step 1:

The user operates the terminal to start a style recommendation application and open an input screen. The terminal displays input fields for user preference information, including text fields for admired items or style descriptions, selection controls for style options, and a control for capturing or selecting a face image.

Input: None (initial user interaction).

Output: A rendered input user interface on the terminal display.

### Step 2:

The user inputs user preference information into the terminal and provides a face image. The user types text such as admired clothing items or style-related descriptions, selects one or more style options, and captures a face image using the terminal camera or selects a stored face image from local storage.

Input: User touch or keyboard operations and captured image data.

Output: A local data structure in the terminal containing text preference data and an image file reference.

### Step 3:

The terminal packages the user preference information and the face image into a request message and sends the request to the server. The terminal encodes the text into a structured format such as JSON, attaches the face image as binary data, sets appropriate communication headers, and transmits the request over a network.

Input: Local preference data structure and image file reference.

Output: A network request containing structured user preference information and image data, delivered to the server.

### Step 4:

The server receives the network request and parses the included data. The server uses a web framework to read the request body, separate the JSON fields representing user preference information, and store the image file in temporary storage. The server validates data types, checks mandatory fields, and verifies image format and size.

Input: Network request including JSON text and image binary data.

Output: Validated preference text, validated style option values, and a stored face image file path in server memory or storage.

### Step 5:

The server normalizes the user preference information into at least one style attribute. The server tokenizes the preference text, removes function words, and maps detected style-related terms to higher-level categories using a synonym mapping table. The server combines explicit style options chosen by the user with mapped categories to decide a final style attribute.

Input: Validated preference text and style option values.

Output: One or more normalized style attributes stored in association with the current request.

### Step 6:

The server stores initial request data in a database. The server generates a unique request identifier, creates a record that includes the user identifier if available, the normalized style attributes, the raw preference text, and the face image file path, and writes this record to a request table.

Input: Normalized style attributes, raw preference text, and face image file path.

Output: A persistent database record keyed by the request identifier.

### Step 7:

The server constructs a first prompt sentence for a generative AI model to generate style proposals. The server retrieves a template matching the normalized style attribute, fills in placeholders with user-specific parameters such as age group or occasion if available, and concatenates the components to form a complete prompt sentence.

Input: Normalized style attributes, template definitions, and optional user parameters.

Output: A first prompt sentence as a text string instructing the generative AI model to generate style proposals.

### Step 8:

The server sends the first prompt sentence to the generative AI model and obtains generated style proposal text. The server encodes the prompt sentence into token identifiers, invokes the generative AI model through an inference API, and receives generated tokens that are decoded into natural language text describing coordinated outfits.

Input: First prompt sentence text.

Output: A generated style proposal text block returned from the generative AI model to the server.

### Step 9:

The server parses and structures the style proposal text into discrete style proposal information records. The server applies pattern matching to detect list markers and sentence boundaries, extracts each outfit description, and splits each description into components such as main garment, accessory, and footwear. The server creates structured records and inserts them into a style proposal table linked to the request identifier.

Input: Generated style proposal text block.

Output: Structured style proposal information stored in database records.

### Step 10:

The server loads and preprocesses the face image for feature extraction. The server reads the image file from storage, resizes it to a standard resolution, converts it to a standard color space, and normalizes pixel values to produce a numeric tensor suitable for neural network input.

Input: Face image file path from the request record.

Output: A preprocessed image tensor representing the face image in main memory.

### Step 11:

The server executes a facial landmark detection network on the preprocessed image tensor to obtain facial feature coordinates. The server forwards the tensor through a neural network implemented in a machine learning framework, and the network outputs a set of coordinate points corresponding to feature locations such as eyes, nose, lips, and jawline.

Input: Preprocessed image tensor.

Output: A set of facial landmark coordinates stored as numerical arrays.

### Step 12:

The server computes shape feature data and color feature data from the facial landmarks and image pixels. The server calculates geometric measures such as ratios and angles from the coordinates to classify eye shape, lip thickness, and face shape, and samples pixel values in regions determined by the landmarks to compute skin tone and undertone. The server converts continuous measures into discrete labels according to predefined thresholds.

Input: Facial landmark coordinates and preprocessed image tensor.

Output: Facial feature data consisting of numerical vectors and categorical labels describing shape features and color features.

### Step 13:

The server stores the facial feature data in association with the request identifier. The server writes a record into a face feature table, including region-based feature vectors and corresponding labels for each major facial region.

Input: Facial feature data and request identifier.

Output: A persistent face feature record linked to the request in the database.

### Step 14:

The server creates a second prompt sentence that combines style proposal information with facial feature data to request makeup method proposals from the generative AI model. The server selects one or more style proposal records, converts them into concise textual descriptions, appends facial feature labels, and formats the combination into a detailed instruction for makeup generation.

Input: Structured style proposal information and facial feature data.

Output: A second prompt sentence text instructing the generative AI model to generate makeup method proposals.

### Step 15:

The server submits the second prompt sentence to the generative AI model and obtains generated makeup method proposal text. The server encodes the prompt sentence, runs inference on the generative AI model, and decodes the output tokens into natural language instructions that describe a complete makeup look and application steps.

Input: Second prompt sentence text.

Output: Generated makeup method proposal text returned from the generative AI model.

### Step 16:

The server segments and structures the makeup method proposal text into region-specific instructions. The server detects headings or cue phrases indicating regions such as eyes, cheeks, lips, and eyebrows, splits the text by these markers, and associates each segment with a facial region identifier.

Input: Generated makeup method proposal text.

Output: Structured makeup method proposal information grouped by facial region.

### Step 17:

The server stores the structured makeup method proposal information in the database. The server creates one or more records in a makeup proposal table, including the text for each facial region and a link to the corresponding facial feature record and style proposal record.

Input: Structured makeup method proposal information and relational identifiers.

Output: Persistent makeup proposal records linked to the request.

### Step 18:

The server composes response data that includes style proposal information and region-specific makeup method proposal information. The server retrieves relevant records from the style proposal table and makeup proposal table, converts them into a response object, and embeds mapping data associating facial regions with corresponding text instructions.

Input: Style proposal records and makeup proposal records associated with the request identifier.

Output: A response data structure ready for transmission to the terminal.

### Step 19:

The server sends the response data to the terminal over the network. The server serializes the response data into a structured format, attaches appropriate response headers, and transmits the data through the network interface to the terminal.

Input: Response data structure.

Output: A network response containing structured style and makeup information delivered to the terminal.

### Step 20:

The terminal receives the response and renders the style and makeup information for the user. The terminal parses the structured data, generates layout elements for each style proposal, and displays text descriptions on the display. The terminal also displays the user's face image and overlays markers or icons near corresponding facial regions according to the region mapping, and associates each marker with the appropriate segment of the makeup instructions.

Input: Network response with structured style and makeup information.

Output: A rendered user interface presenting style proposals and mapped makeup instructions to the user.

### Step 21:

The user reviews the presented style proposals and makeup instructions on the terminal and may request refinement. The user selects interface controls indicating additional conditions such as higher or lower formality, cost adjustments, or makeup intensity changes.

Input: Visualized style and makeup information on the display.

Output: User-generated refinement parameters captured by the terminal.

### Step 22:

The terminal packages the refinement parameters and sends an update request to the server. The terminal incorporates the original request identifier and the new refinement conditions into a structured message and transmits it to the server.

Input: Refinement parameters and stored request identifier.

Output: A network update request containing refinement conditions delivered to the server.

### Step 23:

The server generates an update prompt sentence incorporating the refinement conditions and previously stored proposal information. The server retrieves prior style and makeup records, extracts key descriptors, and uses these along with refinement parameters to construct a new prompt sentence that instructs the generative AI model to modify or regenerate proposals.

Input: Refinement parameters, previous style proposal information, and makeup proposal information.

Output: An update prompt sentence text for the generative AI model.

### Step 24:

The server submits the update prompt sentence to the generative AI model, processes the model output, and updates stored style and makeup proposal records. The server performs inference, parses and structures the newly generated text, and overwrites or augments existing database records associated with the request identifier.

Input: Update prompt sentence text.

Output: Updated structured style proposal information and updated makeup method proposal information stored in the database and made available for subsequent responses to the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional online recommendation systems generally rely on simple rule-based matching or shallow machine-learning models that map user selections directly to pre-defined product categories. These systems typically treat fashion items, cosmetic items, and user appearance as separate domains, and therefore fail to generate coherent, end-to-end coordination proposals. In particular, such systems do not effectively utilize a generative AI model and a dynamically constructed prompt sentence to integrate heterogeneous data, including abstract user preferences, textual style indications, and image-based facial attributes, into a unified inference pipeline.

From a computer-technology perspective, existing architectures suffer from several shortcomings. First, the user's abstract preferences (for example, desired “style,” “reference person,” or “mood”) are often stored as opaque text strings and passed directly to a recommendation engine without structured normalization. This leads to low machine-interpretability, poor reuse of preference data, and an inability to systematically generate or refine AI prompts based on changing user inputs. Second, conventional systems commonly invoke a machine-learning model in a monolithic manner: the input is sent as a fixed, static query, and the output is consumed as a single, flat recommendation set. There is no mechanism for the computing system to decompose the output into structured attributes, re-query internal databases, and iteratively update recommendations in response to user feedback. As a result, the responsiveness and adaptability of the system to user interactions are limited.

Third, known systems rarely implement a pipeline that ties together (i) structured user preference information, (ii) structured face-attribute information derived from image analysis, and (iii) multi-stage prompt sentences targeting different reasoning tasks of a generative AI model, such as fashion proposal generation and cosmetic proposal generation. The lack of such a pipeline results in fragmented processing and requires manual intervention or hard-coded rules to bridge fashion recommendations with cosmetic advice, thereby limiting the scalability and generality of the system.

Fourth, conventional user interfaces for virtual try-on environments generally overlay pre-generated visual content onto user images or avatars without coordinating that content with dynamically updated AI reasoning. Once a recommendation is displayed, subsequent user interactions (for example, changing style, changing use case, or rejecting certain items) may not trigger a coherent regeneration of prompts and re-inference by the generative AI model. This leads to a rigid user experience that does not fully exploit the computational capabilities of modern AI models and distributed server infrastructures.

Accordingly, there is a need for a computer-implemented technique that improves the way a server processes user inputs, generates and manages prompt sentences for a generative AI model, extracts structured attribute information from natural-language outputs, and coordinates these results with internal databases and a virtual try-on user interface. Such a technique should provide a technical improvement to the functioning of the server and the overall computing system by enabling structured, iterative, and integrated processing of fashion recommendations and cosmetic proposals, rather than simply automating a human stylist's workflow.

The specific processing by the specific processing unit 290 of the data processing device 12 in Application Example 1 is realized by the following means.

The present invention provides a server comprising a processor and a memory storing instructions, wherein the processor is configured to execute the instructions to (i) receive, from a user terminal via a communication network, input information including abstract preference information such as an abstract reference object, an abstract style, and an abstract usage situation, convert the input information into structured information, and store the structured information in the memory, (ii) select, on the basis of the structured information, a prompt sentence template from among a plurality of templates, replace variable portions in the template with elements of the structured information so as to generate a first prompt sentence that instructs a generative AI model to generate a fashion proposal, and transmit the first prompt sentence to the generative AI model, (iii) parse natural-language text returned from the generative AI model to extract structured merchandise attribute information including clothing attributes, accessory attributes, and usage-situation attributes, query a product information storage using the merchandise attribute information, and generate recommendation product information to be presented to the user, (iv) analyze face image data received from the user terminal to extract structured face-attribute information including face-shape attributes, color-tone attributes, and part attributes, associate the face-attribute information with the recommendation product information, and generate a second prompt sentence that instructs the generative AI model to generate a cosmetic proposal, (v) parse natural-language text returned from the generative AI model in response to the second prompt sentence to extract cosmetic process information and cosmetic product-attribute information and generate cosmetic proposal information, and (vi) generate user-interface data including at least a part of the recommendation product information and at least a part of the cosmetic proposal information, and transmit the user-interface data to the user terminal so as to enable, in a virtual purchase environment, user operations including selection, trial, and purchase of products related to the recommendation product information. This enables a technical improvement in computer-implemented recommendation processing by providing a server-side architecture that (a) normalizes heterogeneous user inputs into structured information suitable for dynamic prompt construction, (b) transforms unstructured natural-language outputs of a generative AI model into structured attributes usable by database search logic, (c) coordinates fashion and cosmetic reasoning via multi-stage prompt sentences and corresponding AI inferences, and (d) supports iterative, stateful interaction with a virtual try-on interface, thereby improving the efficiency, responsiveness, and integration of the overall computing system.

The term “user terminal” refers to an information processing device operated by a user, including but not limited to a mobile communication device, a wearable device, a tablet device, a personal computer, or any other client device capable of communicating with a server via a communication network and displaying a user interface.

The term “communication network” refers to a wired or wireless communication infrastructure, including but not limited to the Internet, a mobile communication network, a local area network, or any combination thereof, that enables data exchange between the server and the user terminal.

The term “input information” refers to information provided by the user through the user terminal, including at least one of textual, numerical, categorical, or image-based data indicating a user's preferences, styles, reference objects, or other parameters used for generating recommendations.

The term “abstract reference object” refers to a conceptual or symbolic entity specified by the user, such as a category of creator, a type of personality, a genre, or another non-concrete reference that represents a desired stylistic direction or aesthetic.

The term “abstract style” refers to a conceptual characterization of a visual or fashion-related tendency, such as “elegant,” “casual,” “sporty,” or “romantic,” which does not directly specify a particular product but expresses a high-level stylistic preference.

The term “abstract preference” refers to a user's non-specific liking or tendency regarding fashion, cosmetics, or appearance, expressed in a generalized form and not limited to a particular item, brand, or concrete configuration.

The term “structured information” refers to data that has been transformed from raw or free-form user input into a machine-interpretable format with defined fields, attributes, and relationships, such as key-value pairs, records, or object structures suitable for programmatic processing.

The term “storage unit” refers to a hardware and/or software component configured to store data, including but not limited to a memory device, a database, a file system, or a storage service, in which structured information, attribute information, and product information are retained.

The term “prompt sentence” refers to a natural-language expression or instruction sequence generated by the server and provided as input to a generative AI model to cause the generative AI model to perform a designated reasoning or content-generation task.

The term “prompt sentence template” refers to a predefined text pattern or schema including at least one variable portion or placeholder, which is configured to be partially filled or replaced with structured information so as to form a concrete prompt sentence for a generative AI model.

The term “generative AI model” refers to a machine-learning model of a natural-language processing type that, in response to a prompt sentence, generates natural-language text or other content based on probabilistic or neural computation.

The term “natural language text” refers to a sequence of characters or tokens forming expressions in a human language, such as sentences or paragraphs, generated by the generative AI model or provided by the user.

The term “merchandise attribute information” refers to structured data describing characteristics of merchandise, including but not limited to item category, material, color, size, pattern, usage situation, and style tags, which are derived from natural-language text or stored in a database.

The term “clothing attributes” refers to merchandise attribute information specifically related to garments, such as type, silhouette, length, material, pattern, and color.

The term “accessory attributes” refers to merchandise attribute information related to non-garment fashion items, such as shoes, bags, jewelry, headwear, or other add-on items, including type, material, color, and usage.

The term “usage-situation attributes” refers to merchandise attribute information indicating a context, occasion, or environment in which an item is suitable to be used, such as daily use, formal events, outdoor activities, or business settings.

The term “product information storage unit” refers to a storage unit configured to store information on products, including identifiers, descriptions, images, prices, and attribute data, which is searchable by the processor when generating recommendations.

The term “recommendation product information” refers to information on one or more products selected or ranked by the processor, based at least in part on merchandise attribute information obtained from the generative AI model, for presentation as recommendations to the user.

The term “face image data” refers to digital image data containing at least a portion of a human face, captured by the user terminal or another imaging device, and transmitted to the server for analysis.

The term “image processing algorithm” refers to a software-implemented procedure or model that analyzes image data to detect, segment, classify, or measure features within the image, including but not limited to face detection and feature extraction.

The term “face-shape attributes” refers to structured data representing geometric or morphological characteristics of a user's face, such as general face contour, proportions, or relative positions of facial parts.

The term “color-tone attributes” refers to structured data representing color-related characteristics of the user's face image, such as skin tone, hair color, and eye color, expressed in categorical or numerical form.

The term “part attributes” refers to structured data representing local characteristics of specific facial regions, such as eyes, eyebrows, nose, lips, or cheeks, including shapes, sizes, or relative positions.

The term “structured face-attribute information” refers to a collection of face-shape attributes, color-tone attributes, and part attributes organized in a machine-interpretable format and optionally associated with other data such as recommendation product information.

The term “cosmetic prompt sentence” refers to a prompt sentence generated on the basis of structured face-attribute information and recommendation product information, which instructs the generative AI model to generate cosmetic-related natural-language text.

The term “cosmetic proposal information” refers to structured or semi-structured information derived from natural-language text generated by the generative AI model in response to a cosmetic prompt sentence, including cosmetic process information and cosmetic product-attribute information.

The term “cosmetic process information” refers to information describing steps, sequences, or methods for applying cosmetics, including but not limited to base makeup, eye makeup, lip makeup, and cheek makeup procedures.

The term “cosmetic product-attribute information” refers to structured data describing cosmetic products to be used in the cosmetic process, including categories, colors, textures, finishes, and application areas.

The term “user-interface data” refers to data formatted for presentation on the user terminal, including layout information, text, images, and control elements, for enabling display and interaction with recommendation product information and cosmetic proposal information.

The term “virtual purchase environment” refers to an interactive display context provided on the user terminal, in which the user can view, compare, virtually try, and purchase products based on recommendation product information and associated proposals.

The term “virtual trial display unit” refers to a functional component implemented on the user terminal that is configured to superimpose visual representations of products or cosmetic effects onto an image of the user or a virtual body model to simulate wearing or application.

The term “virtual body model” refers to a digital representation of a human body or body part, which may be generic or personalized, used as a base for superimposing representations of clothing, accessories, or cosmetic effects.

The term “proposal candidates” refers to multiple alternative recommendation sets or concepts generated by the generative AI model in response to a prompt sentence, each candidate including at least one combination of items or attributes.

The term “hierarchical structure” refers to an organization of information into multiple levels of abstraction or detail, such as grouping proposal candidates by style category, usage situation, or component items.

The term “inference by the generative AI model” refers to a computational process in which the generative AI model receives a prompt sentence as input and generates corresponding natural-language text or other output based on internal parameters and learned patterns.

The term “iteratively execute” refers to repeatedly performing at least two processing stages, such as prompt generation and inference, in response to updated inputs or user operations, thereby refining or updating outputs over time.

The term “preference of the user” refers to a set of user-specific tendencies, likes, or selection patterns regarding fashion, cosmetics, or appearance, which may change over time and may be inferred or updated based on user operations or explicit inputs.

In one embodiment, a server cooperates with one or more terminals operated by a user to implement a coordinated fashion and cosmetic recommendation system using a generative AI model and dynamically constructed prompt sentences. The server is implemented on general-purpose computer hardware such as a rack-mount server or a virtual machine instance provided by a cloud computing environment. The server includes at least one central processing unit (CPU), a main memory such as a DRAM, a non-volatile storage device such as a solid-state drive, and a network interface. The server executes an operating system, such as a UNIX-like operating system, and an application platform including a web server, an application server, and a database management system.

The terminal is implemented as a mobile communication device, a tablet device, a wearable device, or a personal computer. The terminal includes a display, an input device such as a touch panel, and an imaging device such as a front-facing camera. The terminal executes a web browser or a native application, and communicates with the server via a communication network using a transport protocol such as HTTPS.

The server hosts a web application that provides a virtual purchase environment. The server stores in the storage unit: (i) product information including clothing items and cosmetic items, (ii) a plurality of prompt sentence templates, (iii) structured user preference records, and (iv) parameters of a generative AI model interface. The server further stores executable modules including a user input structuring module, a prompt generation module, an AI inference management module, a text-to-attribute parsing module, an image analysis module, and a user-interface data generation module.

The terminal displays graphical user interface components for collecting input information from the user. The terminal causes a style selection screen, a reference object selection screen, and a usage situation selection screen to be displayed. The terminal accepts entry of an abstract style such as “elegant style,” an abstract reference object such as “a classic high-end look,” or an abstract usage situation such as “evening party.” The terminal also accepts optional textual descriptions entered by the user. The terminal converts these inputs into a structured format, such as a set of key-value pairs, and transmits them to the server via the communication network.

The server receives the input information and executes the user input structuring module. The server normalizes vocabulary by mapping synonyms and variants to canonical tokens stored in a vocabulary table of the database management system. For example, the server maps “formal dinner,” “evening gala,” and “night event” to a common canonical usage situation token “formal evening.” The server stores the structured information in a preference record data structure that includes fields for abstract style, abstract reference object, abstract usage situation, and associated confidence scores.

The server uses explicit data structures to manage the structured information. In one example, the server represents the structured information as a record with a fixed schema consisting of: a user identifier field, an abstract style code field, an abstract reference object code field, a usage situation code field, a timestamp, and a feature vector field. The server computes the feature vector by embedding the canonical tokens into a continuous numerical space using a pre-trained embedding model and stores the resulting high-dimensional vector as part of the record. This structure enables the server to perform similarity search and clustering on preferences across users in an efficient manner.

The server selects a prompt sentence template by consulting a template index table. The template index table associates template identifiers with conditions defined in terms of structured information, such as whether both an abstract style and an abstract reference object are present. The server evaluates these conditions in a deterministic rule engine, implemented using conditional branching logic. For example, if the user has provided both an abstract style and an abstract reference object and has specified a formal usage situation, the server selects a template that emphasizes coordinated, occasion-specific outfits.

The server then executes the prompt generation module. The server performs placeholder substitution by scanning the selected template for variable markers and replacing them with canonical strings derived from the structured information. For example, the server may generate a fashion-proposal prompt sentence such as:

“Please propose fashion items that match an elegant style for an online shopper. The user is looking for an elegant long dress suitable for a formal evening event. Provide 5 item concepts, including color, material, silhouette, and suitable accessories such as shoes and bags.”

In another example, if the user has requested a reference to a certain public figure's casual daily style, the server may generate a prompt sentence such as:

“Please propose a street-style outfit inspired by a casual public figure look. The user prefers a casual but stylish look suitable for weekend city walks. Describe 5 complete outfits, including tops, bottoms, shoes, outerwear, and accessories, with color and material suggestions.”

The server is configured to interface with a generative AI model. In one embodiment, the server accesses an external generative AI model implemented as a neural language model via a model inference API. The generative AI model internally uses a deep neural network having a transformer architecture including multiple layers of self-attention, feedforward sublayers, layer normalization, and residual connections. The generative AI model is trained on a large corpus of text by minimizing a language modeling loss such as cross-entropy loss between predicted token distributions and ground-truth next tokens. The generative AI model uses parameter matrices representing attention weights and feedforward weights, which are updated during training using a gradient-based optimization method such as stochastic gradient descent or a variant thereof.

The server transmits the generated prompt sentence to the generative AI model together with inference parameters such as maximum output length, sampling temperature, and top-k or top-p constraints. The server encapsulates the prompt sentence and the parameters in a request object compliant with the model inference API. The network interface of the server sends the request over the communication network and receives a response containing natural language text generated token by token by the generative AI model.

The server executes the AI inference management module to handle the model outputs. The server collects the stream of generated tokens, reconstructs the natural language text, and passes the text to the text-to-attribute parsing module. The text-to-attribute parsing module is implemented as a combination of pattern matching, part-of-speech tagging, and domain-specific dictionaries. The server segments the generated text into separate item descriptions by detecting list markers or sequence numbers, and within each item description the server identifies attribute phrases corresponding to clothing attributes, accessory attributes, and usage-situation attributes.

The server maintains a domain ontology defining the relationship between words and attribute categories. For example, the server maps “long dress” to a length attribute “long” and an item category “dress,” and maps “navy” to a color attribute “navy blue.” The server stores the extracted attributes as structured merchandise attribute information in a merchandise attribute table linked to product categories. The structured form allows efficient indexing and querying by the database management system.

The server accesses the product information storage unit, which contains records for inventory items. Each record includes a product identifier, a set of attribute fields corresponding to category, size, color, material, style tags, and usage situations, as well as one or more image references. The server executes a query generator to create search queries based on the merchandise attribute information. The server may form SQL queries or search engine queries containing conjunctions and disjunctions of attribute constraints. Because the merchandise attribute information is structured, the server can construct precise queries that avoid broad, high-latency searches, thereby reducing computation time and network load between application and database layers.

The server computes a relevance score for each product by combining multiple factors including attribute match rate, style similarity calculated using vector space distance, popularity metrics, and availability status. The server normalizes these scores and selects a subset of products whose relevance exceeds a threshold. The server constructs recommendation product information by combining these products with explanatory text segments derived from the generative AI model outputs. This structured selection process improves recommendation precision compared to simple keyword matching systems.

The terminal optionally acquires face image data from the user. The terminal activates the imaging device and captures a face image, downsamples the image to a predetermined resolution to control data size, and performs initial compression. The terminal then transmits the face image data to the server via the communication network.

The server executes the image analysis module to process the face image data. In one embodiment, the server uses a convolutional neural network trained for face detection and landmark localization. The convolutional neural network includes convolutional layers, pooling layers, and fully connected layers, and uses an activation function such as rectified linear units. The server feeds the face image into the network, which outputs bounding boxes and landmark coordinates for facial parts including eyes, nose, and mouth. The server computes face-shape attributes by fitting the landmarks to a predefined set of face shapes.

The server computes color-tone attributes by sampling pixel values from skin regions and mapping them to a color space representation, such as a hue-saturation-value space, and classifying the resulting values into skin tone categories.

The server stores the extracted face-shape attributes, color-tone attributes, and part attributes in structured face-attribute information linked to the user identifier and the corresponding session. The server associates the face-attribute information with the recommendation product information to form a combined context. Because this context is stored in a structured format, the server can systematically reuse it when generating subsequent prompt sentences.

The server generates a cosmetic prompt sentence by incorporating both the clothing context and the face-attribute information into a template designed for cosmetic proposals. For example, when the recommendation product information includes a long navy dress and silver accessories, and the face-attribute information indicates fair skin, brown eyes, and an oval face shape, the server may generate a prompt sentence such as:

“The user will wear a long, elegant navy blue dress with silver high heels and a small clutch bag for an evening party. The user has fair skin, brown eyes, and an oval face shape. Please propose a detailed makeup plan, including foundation shade, eye shadow colors, eyeliner style, mascara, lipstick color, and blush placement, that harmonizes with this outfit.”

The server transmits this cosmetic prompt sentence to the generative AI model using the same inference mechanism as the fashion proposal. The generative AI model generates corresponding natural language text describing cosmetic steps and recommended cosmetic product types. The server receives the generated text and passes it to the text-to-attribute parsing module configured for cosmetic content. The server identifies sequences corresponding to base makeup, eye makeup, lip makeup, and cheek makeup, and extracts color descriptors, product categories, and ordering instructions.

The server stores the extracted information as cosmetic proposal information. The structured nature of the cosmetic proposal information allows the server to map recommended cosmetics to concrete items stored in a cosmetic product database, similarly to fashion items.

The server therefore can recommend specific cosmetic products alongside the application steps, improving the practical utility of the proposals.

The server executes the user-interface data generation module to prepare data for presentation on the terminal. The server builds user-interface data representing lists, grids, and detailed views of clothing items and cosmetic guidance. For virtual trial functionality, the server includes references to asset data such as 2D overlays or 3D models of clothing and color palettes for cosmetic effects. The server transmits user-interface data to the terminal via the communication network.

The terminal receives the user-interface data and renders interactive screens. In one embodiment, the terminal uses an augmented reality library to superimpose a representation of the selected clothing item onto a captured image of the user or onto a virtual body model.

The terminal also applies cosmetic color overlays computed from the cosmetic proposal information onto the user's face image. The terminal accomplishes this by mapping face-attribute information and landmarks, which are computed by the server and optionally refined on the terminal, to specific pixel regions and blending color values with the original image. This coordinated overlay requires computation of geometric transformations and color transformations, which are defined in a rendering pipeline executed by the terminal.

The server supports an iterative interaction model. When the user changes preferences, such as switching from an elegant style to a casual style, the terminal updates the structured information and transmits it to the server. The server does not merely repeat an identical operation; instead, the server maintains a stateful session and uses the stored feature vectors to compute a difference vector between the previous and updated preferences. The server uses this difference to adjust the selection of prompt sentence templates and to bias the prompt generation accordingly. As a result, the generative AI model receives prompt sentences that explicitly reference the transition in style preferences and can generate proposals that are more stable or vary in a controlled manner, thereby reducing unnecessary changes and network traffic.

Because the server handles structured information and attribute extraction, the system achieves technical improvements over conventional systems. First, the server reduces the amount of data transmitted to and from the generative AI model by generating compact, structured prompt sentences instead of transmitting large volumes of unstructured historical data. Second, the server improves latency and throughput by offloading attribute-level reasoning to deterministic modules, such as the text-to-attribute parsing module, and by performing database searches using precise attribute constraints rather than full-text search on unstructured descriptions. Third, the server improves recommendation precision by combining generative AI model outputs with domain ontologies and structured matching algorithms, thereby reducing noise and inconsistency in the generated recommendations.

The server further improves internal data management. Because all user preferences, merchandise attribute information, and face-attribute information are stored using explicitly defined schemas and linked through foreign keys and unique identifiers, the server can efficiently index, cache, and retrieve data across sessions. The server may use an in-memory cache for frequently accessed attribute combinations to reduce repeated calls to the generative AI model. This caching mechanism reduces network load and computation cost, which is a technical advantage in a multi-user, high-traffic environment.

The generative AI model is trained using a corpus that includes fashion descriptions, cosmetic instructions, and general natural language. The training process includes applying tokenization, data augmentation such as synonym replacement and style variation, and regularization techniques such as dropout in the neural network layers. The server, in some embodiments, periodically fine-tunes a local instance of the model on anonymized attribute-aligned datasets extracted from user interactions. The fine-tuning uses a supervised objective where the target sequences reflect desired attribute patterns, thereby steering the model distributions towards domain-specific behavior. This technical configuration improves prediction accuracy and reduces the need for manual rule updates.

The system does not merely automate human stylist work; the server implements non-conventional, machine-oriented workflows. For example, the server performs attribute extraction using a hybrid of deterministic parsing and vector similarity rather than relying on a stylist's intuition. The server constructs hierarchical prompt sentences that encode meta-information, such as explicit naming of style levels and usage contexts, to guide the generative AI model into producing structured, multi-level outputs. When the server receives hierarchical outputs, the server maps them into nested data structures that reflect the hierarchy, enabling further computational processing such as partial refinement of only one level. This approach is not typically feasible in manual human workflows and thus constitutes an improvement in computational processing.

In alternative embodiments, the server may be configured to host the generative AI model locally rather than accessing it via an external API. In such cases, the server stores model parameters in the storage unit and performs the inference computations on local processing units, which may include graphics processing units or specialized accelerators. This configuration allows tighter integration between prompt generation, inference, and attribute extraction, enabling further optimization such as batching multiple prompt sentences in a single forward pass to reduce per-query overhead.

In another embodiment, the terminal may execute a subset of the modules, such as the image analysis module, locally. In that case, the terminal analyzes face image data and transmits only structured face-attribute information to the server. This reduces the volume of image data transferred over the communication network and may improve privacy. Because the attribute extraction logic is implemented consistently with the server-side version, the overall system behavior remains deterministic and predictable.

In yet another embodiment, the server may adapt the prompt generation strategy based on runtime performance measurements. If the server detects that the generative AI model is exhibiting high latency or unstable output, the server may switch to simpler prompt templates that require less computational complexity in the model or may adjust inference parameters to favor deterministic outputs. This dynamic adaptation allows the server to maintain acceptable response times and user experience under varying system loads.

Through these configurations, the server, the terminal, and the generative AI model cooperate to form a technical system that improves the way recommendations are generated and managed. The system uses specific data structures, algorithmic flows, and neural network configurations to achieve higher precision, faster processing, and lower resource consumption than conventional systems that treat AI output as unstructured text. The architecture thereby provides a concrete technical solution to the problem of integrating heterogeneous user inputs, generative AI model reasoning, structured attribute management, and virtual trial presentation in a scalable and efficient manner.

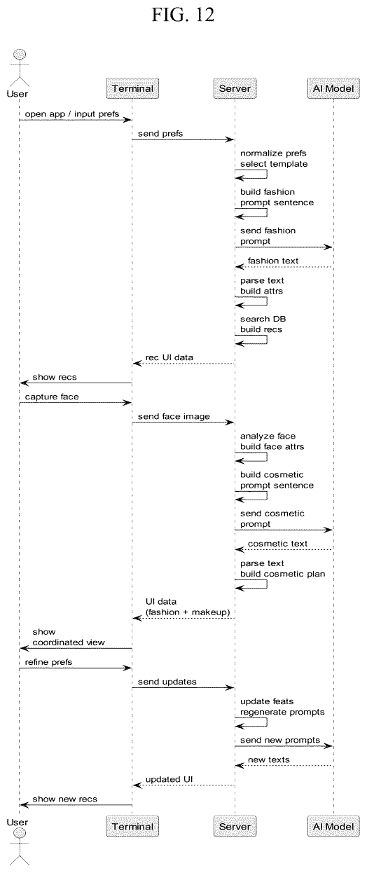

The following describes the processing flow using FIG. 12.

### Step 1:

The user operates the terminal to access a virtual purchase environment and to provide initial preference inputs.

The terminal displays screens including text fields, selection lists, and thumbnail images for abstract style, abstract reference object, and usage situation.

The input of this step is raw user actions such as taps, text entries, and option selections.

The terminal converts these actions into structured input data including fields such as style keyword, reference object keyword, and usage situation keyword, and the output of this step is a structured preference object held in the terminal's local memory.

### Step 2:

The terminal transmits the structured preference object to the server via a communication network.

The input of this step is the structured preference object generated in Step 1.

The terminal serializes the structured preference object into a request message, attaches metadata such as a session identifier and timestamp, and sends the request using a network protocol such as HTTPS.

The output of this step is a network request containing user preference data delivered to the server.

### Step 3:

The server receives the request and parses the structured preference object.

The input of this step is the request message transmitted from the terminal.

The server decodes the message, validates the schema, and extracts fields such as abstract style, abstract reference object, and usage situation into internal variables.

The server then writes these values into a normalized preference record in a database, and the output of this step is a stored preference record and corresponding in-memory representation of the structured information.

### Step 4:

The server normalizes the preference text and generates a preference feature vector.

The input of this step is the in-memory structured information from Step 3.

The server applies vocabulary normalization by mapping synonyms and variants to canonical tokens using a lookup table, and then computes an embedding vector for each canonical token using a pre-trained embedding model.

The server concatenates or aggregates these embedding vectors into a single feature vector representing the user's current preference state, and the output of this step is updated structured information including canonical tokens and a numerical feature vector.

### Step 5:

The server selects a prompt sentence template based on the structured information.

The input of this step is the canonical tokens and their presence flags from Step 4.

The server evaluates rule conditions, such as whether all of abstract style, abstract reference object, and usage situation are present, against an index of template conditions.

The server selects one template identifier that best matches the current combination of fields, retrieves the corresponding template text containing placeholder markers, and the output of this step is a chosen prompt sentence template ready for filling.

### Step 6:

The server constructs a fashion prompt sentence by filling placeholders in the template.

The input of this step is the selected template text and the canonical tokens obtained in Step 4.

The server scans the template for placeholder symbols, replaces them with canonical style phrases, reference object descriptions, and usage context phrases, and applies grammatical adjustments such as article selection and pluralization.

The output of this step is a complete fashion-proposal prompt sentence in natural language, for example: “Please propose fashion items that match an elegant style for an online shopper. The user is looking for an elegant long dress suitable for a formal evening event. Provide 5 item concepts, including color, material, silhouette, and suitable accessories such as shoes and bags.”

### Step 7:

The server sends the fashion prompt sentence to the generative AI model and obtains generated fashion text.

The input of this step is the completed prompt sentence from Step 6.

The server encapsulates the prompt sentence and inference parameters, such as maximum token count and sampling temperature, into an API request object and transmits the request to the generative AI model endpoint.

The generative AI model performs internal transformer-based computations using stored weight matrices and attention mechanisms to predict sequences of tokens, and returns natural language text describing fashion proposals.

The output of this step is the generated fashion text received by the server.

### Step 8:

The server parses the generated fashion text to extract merchandise attribute information.

The input of this step is the generated natural language text from Step 7.

The server segments the text into item descriptions by detecting bullet markers, numbering, or sentence boundaries, and then performs part-of-speech tagging and phrase extraction to detect phrases corresponding to item types, colors, materials, silhouettes, and usage situations.

The server maps these phrases to standardized attribute codes using a domain ontology and synonym dictionaries, and the output of this step is structured merchandise attribute information including clothing attributes, accessory attributes, and usage-situation attributes for each proposed item.

### Step 9:

The server searches a product information storage unit using the merchandise attribute information.

The input of this step is the structured merchandise attribute information from Step 8.

The server generates search queries that combine attribute constraints, such as item category, color, and style tag, and executes these queries against a product database or search index.

The server evaluates the returned product records, computes relevance scores based on attribute match rates and preference similarity measured by vector distance, and selects a subset of products as recommendations.

The output of this step is recommendation product information containing product identifiers, attribute values, and associated relevance scores.

### Step 10:

The server combines recommendation product information with explanatory fashion text.

The input of this step is the recommendation product information from Step 9 and the original generated fashion text from Step 7.

The server aligns each recommended product with a corresponding generated description by matching item types and core attributes, and attaches the relevant portions of natural language text to each product entry.

The output of this step is enriched recommendation product information that includes both structured attributes and explanatory sentences for each product.

### Step 11:

The server examines whether face image data is available and, if so, requests or retrieves it.

The input of this step is the current session state, including user identifiers and flags indicating whether face analysis is needed.

If face data is not yet available, the server signals the terminal to offer a face capture option; if face data is already stored, the server retrieves the corresponding face image data or structured face-attribute information.

The output of this step is either a trigger to the terminal to capture a face image or an in-memory representation of the face image data to be analyzed.

### Step 12:

The user captures a face image using the terminal when prompted.

The input of this step is the server's request to provide face image data.

The terminal activates the imaging device, displays a live preview, and guides the user to position the face within a frame, then captures a still image when the user confirms.

The terminal compresses and encodes the image, attaches session information, and transmits the face image data to the server.

The output of this step is a network request containing face image data delivered to the server.

### Step 13:

The server analyzes the face image data to derive structured face-attribute information.

The input of this step is the face image data from Step 12.

The server passes the image through a convolutional neural network to detect facial landmarks and skin regions, then computes numerical descriptors for face shape from the landmarks and color-tone descriptors from the sampled skin pixels.

The server classifies these descriptors into categorical face-shape attributes, color-tone attributes, and part attributes using trained classifiers, and the output of this step is structured face-attribute information stored in memory and associated with the current session.

### Step 14:

The server generates a cosmetic prompt sentence using clothing context and face-attribute information.

The input of this step is the recommendation product information from Step 10 and the structured face-attribute information from Step 13.

The server selects a cosmetic template that expects both outfit description and face attributes, inserts references to key outfit attributes such as color, formality, and accessory type, and inserts face attributes such as skin tone and eye color into designated placeholders.

The server thereby constructs a cosmetic prompt sentence, for example: “The user will wear a long, elegant navy blue dress with silver high heels and a small clutch bag for an evening party. The user has fair skin, brown eyes, and an oval face shape. Please propose a detailed makeup plan, including foundation shade, eye shadow colors, eyeliner style, mascara, lipstick color, and blush placement, that harmonizes with this outfit.”

The output of this step is a complete cosmetic prompt sentence in natural language.

### Step 15:

The server sends the cosmetic prompt sentence to the generative AI model and obtains generated cosmetic text.

The input of this step is the cosmetic prompt sentence from Step 14.

The server encapsulates the cosine prompt sentence and inference parameters in a model request, transmits it to the generative AI model, and receives natural language text describing cosmetic steps and recommended product types.

The generative AI model performs internal neural computations to predict sequences of tokens, and the output of this step is the generated cosmetic text received by the server.

### Step 16:

The server parses the generated cosmetic text to build cosmetic proposal information.

The input of this step is the generated cosmetic text from Step 15.

The server segments the text into logical sections corresponding to base makeup, eye makeup, lip makeup, and cheek makeup, and extracts phrases describing shades, textures, and application order using pattern recognition rules and dictionaries of cosmetic terminology.

The server maps these phrases to standardized cosmetic product-attribute codes and constructs cosmetic process steps as ordered lists, and the output of this step is structured cosmetic proposal information including cosmetic process information and cosmetic product-attribute information.

### Step 17:

The server generates user-interface data that integrates fashion recommendations and cosmetic proposals.

The input of this step is the enriched recommendation product information from Step 10 and the cosmetic proposal information from Step 16.

The server builds data structures describing UI layouts, including item cards for clothing recommendations, text blocks for fashion explanations, and step-by-step panels for cosmetic guidance, and attaches links to media assets such as product images and color palettes.

The output of this step is a comprehensive user-interface data package that can be rendered by the terminal to present coordinated fashion and cosmetic suggestions.

### Step 18:

The terminal receives and renders the user-interface data to present a coordinated view.

The input of this step is the user-interface data package from Step 17.

The terminal parses layout descriptors, loads referenced images, and draws UI components on the display, such as lists of recommended fashion items and a step-wise cosmetic guide.

If virtual trial is supported, the terminal also prepares overlay layers for clothing silhouettes and cosmetic color regions, and the output of this step is an interactive display enabling the user to browse and inspect the coordinated proposals.

### Step 19:

The user interacts with the virtual trial functions and refines preferences.

The input of this step is the rendered interactive interface on the terminal.

The user selects specific items, activates virtual try-on for clothing and cosmetics, and optionally modifies preferences such as style or usage situation.

The terminal records these interactions, updates local state, and transmits updated preference information and selection feedback to the server, and the output of this step is new structured preference and interaction data for further processing.

### Step 20:

The server updates recommendation logic based on refined preferences and iteratively regenerates prompt sentences and recommendations.

The input of this step is the updated preference and interaction data from Step 19 and the previously stored preference feature vectors.

The server computes a difference vector between old and new preferences, adjusts template selection and placeholder values accordingly, and regenerates new fashion and cosmetic prompt sentences that reflect the refined requirements.

The server repeats Steps 6 through 17 with updated inputs, thereby producing refined recommendation product information and cosmetic proposal information, and the output of this step is a new set of coordinated recommendations that respond to the user's evolving preferences.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional style recommendation systems that propose cosmetics and clothing typically rely on manually designed rules or coarse user profiles such as age, gender, and general style preferences. These systems are often implemented as separate modules for image analysis and recommendation logic, with limited integration and minimal use of rich facial feature data. As a result, they fail to exploit available computing resources and modern machine-learning techniques in a way that efficiently transforms raw image data into precise, machine-usable representations and, ultimately, into personalized proposals.

In particular, existing systems encounter several technical problems. First, processing pipelines from face image acquisition to recommendation generation are frequently ad hoc, with loose coupling between image processing components and downstream recommendation engines. This leads to redundant computations, inefficient data formats, and increased latency, which are particularly problematic in networked environments where user terminals communicate with remote servers. Second, existing systems often treat image analysis and natural language generation as independent processes, resulting in loss of information when converting from numerical feature space to textual recommendations and making it difficult to systematically control the behavior of generative models. Third, server-side resources, such as processors executing image analysis programs and machine learning models, are not optimally orchestrated to produce structured, reusable data that can support both cosmetic proposals and clothing recommendations in a unified manner.

Moreover, many systems send raw or minimally processed images to generative artificial intelligence services or rely on the generative model to infer low-level visual attributes directly, which increases computational load, network bandwidth usage, and variability in output quality. Without a well-defined intermediate representation, such as structured numerical feature data and systematically constructed prompt sentences, it is difficult to ensure consistency, reproducibility, and controllability of the generated content. This can result in proposals that are not closely aligned with the user's facial characteristics or selected style context, and can also increase the need for manual post-processing.

Accordingly, there is a need for a computer-implemented technique that improves the internal operation of a server in a networked recommendation system by: (i) standardizing the transformation from raw image data to structured numerical feature data using dedicated image processing and machine learning programs; (ii) converting such numerical feature data into controlled natural-language appearance descriptions; (iii) automatically constructing prompt sentences tailored for generative artificial intelligence models; and (iv) using the generated results as structured, machine-readable data that can be efficiently combined with other information resources, such as a storage device storing clothing-related information. By addressing these technical issues, the system can reduce latency, improve resource utilization, increase the precision and consistency of recommendations, and enhance the overall reliability of the computer system itself.

The specific processing by the specific processing unit 290 of the data processing device 12 in Example 2 is realized by the following means.

The present invention provides a server comprising a processor configured to acquire, from a terminal operated by a user, a person image selected by the user, detect a face region from the person image, preprocess the person image, and convert the person image into structured image data; detect facial feature points from the structured image data by using an image processing program, and calculate numerical feature data including feature values related to skin color, eye shape, lip shape, and face contour by using a machine learning program; convert the numerical feature data into an appearance description in natural language based on predetermined correspondence rules, and automatically generate a prompt sentence to be input to a generative artificial intelligence model by combining the appearance description with style information input by the user; transmit the prompt sentence to an external generative artificial intelligence model and receive, from the external generative artificial intelligence model, text data or image data including a cosmetic proposal corresponding to the appearance description and the style information; convert the text data or the image data into display data suitable for viewing on the terminal; and, in some embodiments, generate the cosmetic proposal as structured data in which recommended colors, textures, and application procedures are divided for each region including base makeup, eye makeup, cheek makeup, and lip makeup, and search a storage device storing clothing-related information based on the numerical feature data and the style information to select clothing candidates consistent with the cosmetic proposal and include information on the clothing candidates in the display data. This enables an integrated computer-implemented processing pipeline in which the server transforms raw image data into structured numerical feature data, controlled natural-language prompt sentences, and structured recommendation data, thereby improving computational efficiency, reducing network and processing overhead, and enhancing the precision, consistency, and controllability of cosmetic and clothing proposals generated by the overall system.

The term “system” refers to an arrangement of one or more computing devices, communication interfaces, and storage resources that cooperate to perform the processing described in the claims.

The term “processor” refers to one or more hardware processing units, such as a central processing unit or a graphics processing unit, capable of executing instructions of an image processing program, a machine learning program, and control logic to implement the claimed functions.

The term “terminal” refers to an electronic device operated by a user, including but not limited to a mobile communication device, a portable information processing device, or a desktop computing device, that can capture, store, and transmit image data and display information received from a server.

The term “person image” refers to digital image data representing at least a portion of a human subject, including a face region suitable for analysis of facial features.

The term “face region” refers to a sub-region of a person image that includes at least the eyes, nose, mouth, and surrounding facial contour of the subject.

The term “preprocess” refers to performing one or more operations on raw image data, such as decoding, resizing, cropping, rotating, color-space conversion, normalization, or noise reduction, to obtain image data in a format suitable for subsequent analysis.

The term “structured image data” refers to image data that has been preprocessed and organized in a standardized representation, such as a tensor or array having predefined dimensions and channels, suitable for input to an image processing program or a machine learning program.

The term “image processing program” refers to software instructions executed by the processor to perform operations on image data, including detection of regions of interest, extraction of feature points, and geometric analysis, without requiring training or adaptation on the target data.

The term “machine learning program” refers to software instructions executed by the processor to perform inference using a pre-trained statistical model or neural network that maps input data, such as structured image data, to output data, such as numerical feature data, based on learned parameters.

The term “facial feature points” refers to a plurality of landmarks on a human face, including points around the eyes, nose, mouth, and jawline, that are detected from image data and used for geometric and appearance analysis.

The term “numerical feature data” refers to one or more numerical values or vectors that represent characteristics of a face, including but not limited to skin color, eye shape, lip shape, and face contour, derived from image analysis by the machine learning program.

The term “skin color” refers to one or more numerical attributes representing the tone, brightness, and chromaticity of the skin of the subject, including information on relative lightness and undertone.

The term “eye shape” refers to a classification or parameterization of the geometry of an eye region, including attributes such as width, height, curvature, and eyelid configuration, represented as numerical values or category probabilities.

The term “lip shape” refers to a classification or parameterization of the geometry of a mouth and lips, including attributes such as fullness, width, and contour, represented as numerical values or category probabilities.

The term “face contour” refers to the overall outline or shape of a face, including the relationship between width and height and the configuration of the jaw and cheek areas, represented as numerical descriptors or category labels.

The term “appearance description” refers to a natural-language text representation of the user's facial characteristics, generated from numerical feature data based on correspondence rules, and including at least one phrase that describes visual attributes of the face.

The term “correspondence rules” refers to a predefined mapping between ranges or patterns of numerical feature data and associated natural-language expressions used to generate an appearance description.

The term “style information” refers to information indicating a desired aesthetic or context, including but not limited to clothing style, occasion type, brand preference, or example image category, that is input by the user or otherwise provided to the system.

The term “prompt sentence” refers to a natural-language text string that includes at least an appearance description and style information and is constructed for input to a generative artificial intelligence model to control generation of output content.

The term “generative artificial intelligence model” refers to a machine learning model, such as a language model or an image generation model, that generates text data, image data, or other content in response to a given prompt sentence.

The term “text data” refers to machine-readable natural-language content generated by the generative artificial intelligence model, including cosmetic proposals and related explanations.

The term “image data” refers to digital image content, such as a bitmap or encoded image file, generated by the generative artificial intelligence model and representing at least a visualization of a cosmetic proposal.

The term “cosmetic proposal” refers to recommended cosmetic products, colors, textures, or application techniques that are tailored to the user's facial characteristics and style information.

The term “display data” refers to data formatted for presentation on a terminal, including layout, text segments, and image references, derived from text data or image data generated by the generative artificial intelligence model.

The term “structured data” refers to data organized according to a predefined schema, such as fields corresponding to base makeup, eye makeup, cheek makeup, and lip makeup, each including attributes for colors, textures, and application procedures.

The term “base makeup” refers to cosmetic elements applied to the skin surface to create a foundation, including foundation, concealer, contour, and related products.

The term “eye makeup” refers to cosmetic elements applied to the eye region, including eyeshadow, eyeliner, mascara, and related products.

The term “cheek makeup” refers to cosmetic elements applied to the cheek region, including blush, bronzer, and highlighter.

The term “lip makeup” refers to cosmetic elements applied to the lips, including lipstick, lip gloss, and lip liner.

The term “storage device storing clothing-related information” refers to a memory component, such as a non-volatile storage unit or database system, that stores data describing attributes of clothing items or clothing categories, including colors, styles, and usage contexts.

The term “clothing candidates” refers to one or more clothing items or item types selected from clothing-related information based on numerical feature data and style information and determined to be consistent with a cosmetic proposal.

In one embodiment, a server, a terminal, and a communication network cooperate to implement the claimed system. The server includes at least one central processing unit, at least one graphics processing unit, a volatile memory, a non-volatile storage device, and a network interface. The terminal includes a processor, a memory, an image capturing device, a display device, and a network communication interface. The network includes a wired or wireless communication infrastructure that supports secure data transfer using a standardized protocol.

The server executes an operating system and multiple programs including an image processing program, a machine learning program, a prompt generation program, a communication control program, and a display data generation program. The image processing program may be implemented using a computer vision library such as OpenCV. The machine learning program may be implemented using a deep learning framework such as TensorFlow. The prompt generation program runs on the server processor and constructs a prompt sentence for a generative AI model based on data produced by the image processing program and the machine learning program. The generative AI model may be a text generation model or an image generation model provided by a remote computing resource.

The terminal acquires a person image by using a camera module or by retrieving an existing image from local storage. The terminal converts the captured or selected image into digital image data such as a compressed image file. The terminal transmits the image data and user-provided style information to the server over the network. The terminal receives display data from the server and renders it on the display device for the user.

The server receives the person image from the terminal and stores the image in the storage device. The server converts the stored image into a structured image data format using the image processing program. The server decodes the image file into an array of pixel values, converts the color space if necessary, and normalizes the size and resolution to a standard specification. The server generates a multidimensional tensor representation of the person image for subsequent analysis.

The server detects a face region in the person image using a trained face detector. The server uses an algorithm such as a cascade classifier or a convolutional neural network-based detector to locate the coordinates of the face region. The server crops the person image to the face region and performs optional rotation or alignment based on the relative positions of facial components. The server generates a normalized face image tensor that is size-normalized and orientation-corrected.

The server detects facial feature points in the normalized face image. The server uses a landmark detection algorithm to obtain a set of point coordinates corresponding to the eyes, nose, mouth, and jawline. The server stores these coordinates as facial feature point data. The server calculates geometric features such as distances, angles, and ratios from the facial feature point data. These features include, for example, an eye width-to-height ratio, a mouth width relative to face width, and a jawline curvature index.

The server executes the machine learning program on the normalized face image tensor. The server loads a trained neural network model that receives the face image tensor as input and outputs numerical feature data. In one embodiment, the neural network model is a convolutional neural network including an input layer, a plurality of convolutional layers with rectified linear unit activation functions, pooling layers, one or more fully connected layers, and an output layer. The output layer produces numerical feature vectors corresponding to attributes such as skin color parameters, eye shape probabilities, lip shape scores, and face contour classifications.

The server calculates the numerical feature data by a forward propagation of the input tensor through the neural network. The server stores, for example, a multidimensional vector representing skin color in a perceptual color space, probability distributions over eye shape categories, numerical scores representing lip fullness and shape, and category scores for face shape. The server uses floating-point arithmetic on the processor and may use the graphics processing unit to accelerate matrix operations and convolutions, thereby improving the computational speed compared to a purely CPU-based implementation.

The server converts the numerical feature data into an appearance description in natural language by applying correspondence rules stored in the storage device. The server maps ranges of skin color parameters to descriptive phrases such as “fair skin with cool undertones” or “medium-dark skin with warm undertones.” The server maps eye shape probabilities to terms such as “almond-shaped eyes,” “round eyes,” “monolid eyes,” or “hooded eyes” based on the highest-probability category and predefined thresholds. The server maps lip shape scores to descriptors such as “full lips” or “thin lips.” The server maps face contour classifications to descriptors such as “oval face,” “round face,” or “heart-shaped face.”

The server combines the generated appearance description with style information received from the terminal. The style information may include a clothing style category, an event type, a preferred color tone, or a brand preference. The server generates a structured text that summarizes the appearance description and the style information in a consistent template.

The server then converts this structured text into a prompt sentence suitable for input to a generative AI model.

The server constructs the prompt sentence by concatenating the appearance description and the style information with instructions that specify an output format for the generative AI model. In one example, the server generates a prompt sentence such as:

“The user has medium-light warm skin, almond-shaped brown eyes, full lips, and an oval face, and is wearing a red evening dress. As a professional makeup artist, propose a detailed evening makeup look. Include foundation shade, concealer and contour suggestions, eyeshadow colors and placement, eyeliner style, mascara type, blush color, and lip color. Provide step-by-step application tips in clear bullet points.”

In another example, the server generates a prompt sentence such as:

“The user has fair skin with cool undertones, almond-shaped dark brown eyes, and medium-full lips, and is wearing a blue casual dress. As a professional makeup consultant, suggest a natural daytime makeup look. Provide foundation and concealer recommendations, soft eyeshadow colors, eyeliner style, mascara type, blush color, and lip color. Use concise bullet points and explain why each choice matches the user's features and outfit.”

In a further example, the server generates a prompt sentence such as:

“The user has light skin with cool undertones, monolid eyes, and is wearing a black formal suit. Suggest a sophisticated evening makeup look suitable for a formal event. Describe base makeup, eye makeup techniques specifically for monolid eyes, eyeliner style, mascara, blush, and lip color options. Return the answer as structured sections: Base, Eyes, Cheeks, Lips, and Final Tips.”

The server transmits the prompt sentence to a generative AI model via the network interface.

The server uses a communication protocol such as HTTPS and packages the prompt sentence into a request format. The server may specify control parameters such as output length, randomness, or structure constraints. The generative AI model runs on an external computing environment and processes the prompt sentence using a neural network architecture such as a transformer language model. The generative AI model outputs text data or image data responsive to the prompt sentence.

The server receives the response from the generative AI model. The server extracts the generated text data or image data and stores it in the storage device. The server parses the generated text to identify sections corresponding to base makeup, eye makeup, cheek makeup, and lip makeup. The server converts the text into structured data objects, each including fields for recommended color, texture, and application procedure.

The server generates display data based on the structured cosmetic proposal and, optionally, clothing information. The server adapts the display data to the terminal characteristics such as screen size and resolution. The server may generate markup data that describes the layout of sections, headings, bullet lists, and images. The server compresses the display data if necessary and transmits it to the terminal.

The terminal receives the display data from the server. The terminal parses the display data and renders the content on the display device. The terminal shows distinct sections for base makeup, eye makeup, cheek makeup, and lip makeup, with recommended colors and step-by-step instructions. The terminal may display an image illustrating the proposed makeup, generated by an image-based generative AI model, if such image data is included in the display data. The user views the rendered proposal and may scroll or select components for further detail.

The server may also search a storage device that stores clothing-related information. The server uses the numerical feature data and the style information as query parameters to identify clothing items or categories that harmonize with the cosmetic proposal. The server selects clothing candidates based on color compatibility, formality level, and user preferences. The server includes clothing candidate descriptions and images in the display data sent to the terminal.

The server improves computer technology by defining a structured pipeline from image acquisition through numerical feature extraction, natural-language appearance description, prompt sentence construction, and structured output generation. The server reduces communication load by sending compact prompt sentences and structured feature vectors instead of high-resolution images to the generative AI model. The server improves processing efficiency by standardizing the image preprocessing and feature extraction steps on the server hardware and by using the graphics processing unit for parallelized matrix operations.

The server enhances accuracy and consistency by using a neural network trained with a supervised learning method on a large dataset of annotated face images. The server minimizes an objective function during training such as a cross-entropy loss for categorical attributes and a mean squared error for continuous attributes. During training, the server updates the neural network parameters by an optimization algorithm such as stochastic gradient descent or Adam. The server may perform data augmentation such as random cropping, rotation, and color perturbation to improve robustness of the model and reduce overfitting. As a result, the deployed model provides stable numerical feature data for a wide variety of input images, which improves the reliability of the subsequent recommendation process.

The server applies non-conventional processing rules when converting numerical feature data into the appearance description. The server uses nonlinear mappings and category-specific thresholds that differ from straightforward human textual annotation. For example, the server may combine multiple numerical indicators, such as skin brightness, hue, and saturation, into a single descriptor category using a lookup table or a decision tree tuned for generative AI control. This layered conversion from raw image pixels to high-level descriptors allows the server to exercise fine-grained control over the generative AI model's behavior that is not achievable by manual rule-based systems or direct human input alone.

The server employs a specific data structure for the numerical feature data and appearance description. The server represents the numerical feature data as a feature vector with fixed positions for skin color parameters, eye shape probabilities, lip shape scores, and face contour labels. The server represents the appearance description as a structured text object with predefined slots, such as “skin_descriptor,” “eye_descriptor,” “lip_descriptor,” and “face_shape_descriptor.” The prompt generation program concatenates these slots with style descriptors and instruction phrases in a deterministic manner. This standardized data structure reduces ambiguity and variance in the prompt sentence, which in turn improves the predictability and consistency of the generative AI model output.

The server thus provides a technical effect in that the internal processing of the computing system is improved. The modularization and structuring of numerical feature extraction, text mapping, and prompt construction reduce redundant computations and avoid repeated parsing or heuristic logic at the generative AI side. The server can cache numerical feature data and appearance descriptions so that changes in style information do not require reprocessing of the image. As a result, when the user requests alternative styles for the same person image, the server only regenerates prompt sentences and reuses the existing numerical feature data, which reduces processing time and computational load.

The server also improves the quality of generated content by imposing structured constraints on the generative AI model through the prompt sentence. By specifying clear sections and output formats, the server enables the generative AI model to produce text that can be directly converted into structured recommendation data without extensive natural language understanding on the server side. This reduces the complexity of post-processing algorithms and mitigates the risk of misinterpretation, thereby improving the overall system reliability.

In another embodiment, the server performs additional analysis of clothing style from the person image itself by running a separate machine learning model. The server extracts clothing color distributions and pattern descriptors from regions of the person image outside the face region. The server encodes these descriptors in the numerical feature data structure and reflects them in the appearance description and prompt sentence. This variant further reduces the need for user input of style information and enhances automation while maintaining a clear, technically grounded data flow.

In yet another embodiment, the server includes an on-premises generative AI model rather than using a remote service. The server executes a transformer-based language model locally, with parameters stored in the storage device. The server loads the model into memory and runs inference on the processor and the graphics processing unit. The server partitions the model's parameters for efficient memory access and parallelization. This configuration reduces network dependency and latency and may be advantageous in environments with strict data privacy requirements.

In each embodiment, the server interacts with the terminal through well-defined data formats and communication protocols. The server uses compact structured data, precomputed feature vectors, and deterministic prompt construction to address technical constraints such as limited bandwidth, processing time, and memory capacity. As a result, the claimed system provides improvements in computational efficiency, data management, communication overhead, and the precision and consistency of cosmetic and clothing proposals, beyond merely automating a manual process.

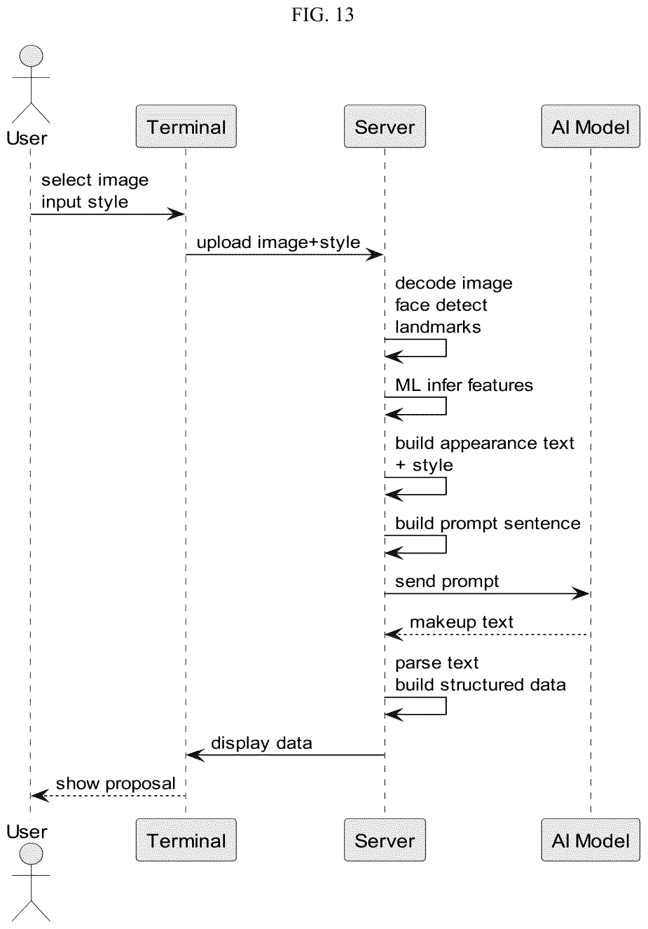

The following sescribes the processing flow using FIG. 13.

### Step 1:

User operates the terminal to provide input.

User selects a person image stored on the terminal or captures a new image using a camera function of the terminal. User optionally inputs style information such as a desired occasion, preferred color tone, or clothing style through a graphical user interface.

Input: a raw image file (for example, JPEG or PNG) and style information entered as text or selected options.

Output: user-selected image data and style information held in the terminal's memory.

### Step 2:

Terminal transmits the input to the server.

Terminal reads the selected image file from local storage, encodes it into a suitable transmission format such as multipart/form-data or a binary HTTP body, and attaches metadata including user identification and style information. Terminal establishes a secure connection to the server via a network protocol and sends an HTTP request containing the encoded image data and style information.

Input: user-selected image data and style information in local data structures.

Output: a network request message containing the image data and style information transmitted to the server.

### Step 3:

Server receives and stores the person image.

Server accepts the network request from the terminal via a network interface, parses the HTTP headers and body, and extracts the image data and style information. Server validates the file type and size, and then writes the image data into a non-volatile storage device, such as a file system or object storage, assigning a unique identifier. Server stores the style information and the identifier in a session record in a database or memory.

Input: network request including encoded image data and style information.

Output: stored image file on the server and a session record containing the image identifier and style information.

### Step 4:

Server decodes and preprocesses the person image.

Server loads the stored image file from the storage device into volatile memory and passes it to an image processing program. Server decodes the compressed image into a two-dimensional or three-dimensional array of pixel values. Server converts the color space (for example, from BGR to RGB), resizes the array to a standard resolution, and normalizes pixel values into a numerical range suitable for analysis. Server constructs a tensor representing the preprocessed person image.

Input: stored image file and associated identifier.

Output: preprocessed image tensor representing the person image in a normalized format.

### Step 5:

Server detects the face region and aligns the face.

Server applies a face detection algorithm, such as a trained classifier or a convolution-based detector, to the preprocessed image tensor to estimate bounding box coordinates of the face. Server crops the tensor to the face region and computes an affine transformation to align the face based on estimated positions of eyes or other facial components. Server generates an aligned face tensor with standardized orientation and spatial layout.

Input: preprocessed image tensor.

Output: aligned face tensor and face region coordinates.

### Step 6:

Server detects facial feature points.

Server processes the aligned face tensor with a landmark detection algorithm implemented in the image processing program. Server calculates the positions of a plurality of facial feature points, including points around the eyes, nose, mouth, and jawline. Server stores these points as a set of coordinate pairs or triplets. Server computes additional geometric quantities, such as distances between key points, relative angles, and aspect ratios, by simple arithmetic operations on the coordinates.

Input: aligned face tensor.

Output: facial landmark coordinates and derived geometric feature values.

### Step 7:

Server extracts numerical feature data with a machine learning program.

Server feeds the aligned face tensor into a neural network model implemented in a machine learning framework. Server performs forward propagation through multiple layers of the model, including convolution operations, activation functions, and fully connected layers, to convert image data into abstract feature representations. Server obtains numerical outputs such as skin color vectors, eye shape probability distributions, lip shape scores, and face contour category scores. Server aggregates these outputs into a unified numerical feature vector.

Input: aligned face tensor.

Output: numerical feature vector representing skin color, eye shape, lip shape, face contour, and other facial attributes.

### Step 8:

Server maps numerical features to an appearance description.

Server accesses correspondence rules stored in memory and compares elements of the numerical feature vector with predefined thresholds and category boundaries. Server selects text descriptors corresponding to the detected ranges, such as “fair skin with cool undertones” or “almond-shaped eyes.” Server concatenates the selected descriptors into a coherent natural-language appearance description, maintaining a fixed ordering of facial attributes.

Input: numerical feature vector and correspondence rules.

Output: appearance description in natural language that summarizes facial characteristics.

### Step 9:

Server integrates style information with the appearance description.

Server retrieves the style information from the session record and analyzes it to identify style parameters such as event type or color preference. Server merges the style parameters with the appearance description by inserting the style phrases into predefined positions in a template. Server creates an intermediate structured text object with fields for facial description, clothing or event context, and user preferences.

Input: appearance description and style information.

Output: integrated appearance-and-style description stored in a structured text object.

### Step 10:

Server generates a prompt sentence for a generative AI model.

Server applies a prompt generation program to the structured text object. Server selects a template that specifies the role (for example, professional makeup artist), the required output sections, and the desired detail level. Server substitutes the appearance-and-style description into the template and adds explicit instructions for output format, such as section headings and bullet points. Server constructs a single prompt sentence or a short group of sentences.

Input: structured text object containing appearance-and-style description.

Output: prompt sentence formatted for input to a generative AI model.

### Step 11:

Server transmits the prompt sentence to the generative AI model.

Server wraps the prompt sentence in a request message according to an application programming interface specification. Server includes control parameters such as maximum token count or output diversity. Server sends the request to the generative AI model over a network. Server waits for a response and, if necessary, applies retry logic or timeout handling.

Input: prompt sentence and control parameters.

Output: request message sent to the generative AI model and a pending state awaiting generated content.

### Step 12:

Server receives generated text data or image data from the generative AI model.

Server reads the response message returned by the generative AI model and extracts the generated content field. Server separates text data and image data if both are present. Server stores the raw generated data in the storage device, associating it with the original session record.

Input: response message from the generative AI model.

Output: stored generated text data and optional generated image data linked to the session.

### Step 13:

Server converts generated text into structured cosmetic proposal data.

Server analyzes the generated text using parsing rules or delimiter patterns specified in the prompt sentence, such as headings “Base,” “Eyes,” “Cheeks,” and “Lips.” Server splits the text into segments for each cosmetic region and further divides each segment into recommended colors, textures, and application steps. Server creates a structured data representation with separate fields for each region and attribute type.

Input: generated text data.

Output: structured cosmetic proposal data organized by facial region and parameter.

### Step 14:

Server optionally associates clothing candidates with the cosmetic proposal.

Server queries a storage device that contains clothing information using numerical feature data and style information as search criteria. Server filters clothing entries based on color compatibility and formality level. Server selects one or more clothing candidates and attaches their identifiers and descriptive attributes to the structured cosmetic proposal data.

Input: numerical feature vector, style information, and clothing information database.

Output: augmented structured proposal data including cosmetic content and clothing candidates.

### Step 15:

Server generates display data for the terminal.

Server converts the structured proposal data and any generated image data into a display format. Server creates a layout description that arranges base makeup, eye makeup, cheek makeup, and lip makeup into separate sections. Server embeds text strings, color labels, and step-by-step instructions, and attaches image references. Server compresses or serializes the display data into a format suitable for transmission, such as a structured text or markup format.

Input: structured cosmetic proposal data and optional generated image data.

Output: display data package ready to be sent to the terminal.

### Step 16:

Server transmits the display data to the terminal.

Server opens a response channel to the terminal, attaches the display data to a response message, and sends the message over the network. Server may include status information indicating completion of processing.

Input: display data package.

Output: network response containing display data delivered to the terminal.

### Step 17:

Terminal renders the display data for the user.

Terminal receives the response message from the server and parses the display data. Terminal maps layout instructions to user interface components and displays sections for base, eyes, cheeks, and lips on the display device, along with any images. Terminal adjusts fonts, spacing, and scroll behavior according to local user interface rules. Terminal presents an interactive view that allows the user to read, scroll, and optionally save the proposal.

Input: display data received from the server.

Output: rendered visual presentation of the cosmetic proposal and associated clothing suggestions on the terminal screen.

### Step 18:

User reviews and optionally requests further proposals.

User observes the displayed recommendations and may decide to request variations, such as a different style or event context. User interacts with controls on the terminal interface to send updated style information or to upload another person image.

Input: rendered proposal and user interaction elements.

Output: new user commands and possibly new image and style inputs sent back to the terminal and then to the server, initiating another processing cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional fashion and cosmetic recommendation systems primarily implement static rule-based matching between user selections and catalog data. Such systems generally treat (i) user style preferences, (ii) user facial characteristics, and (iii) user emotional state as independent or are unable to jointly utilize these heterogeneous data types in a unified computational pipeline. As a result, the underlying computer processing often degenerates into simple database lookups keyed only by coarse style labels, without taking into account fine-grained face feature extraction, dynamic emotion recognition, or adaptive use of generative AI models.

In particular, existing systems typically face the following technical problems. First, conventional systems do not integrate image analysis of user face images and emotion analysis into the same control flow that drives product retrieval from storage circuitry, which limits the ability of the processor to compute context-aware ranking or selection of items. Second, where generative AI models are employed, prompt sentences are often constructed in an ad hoc manner, without a systematic mechanism in the processor for programmatically composing prompts from structured attributes, facial feature vectors, and emotion states stored in memory. This limits the effectiveness and reproducibility of generative outputs, and results in non-deterministic or poorly aligned recommendation content. Third, conventional architectures do not generate intermediate rendering parameters, such as decorative parameters per face region, that are directly consumable by an augmented reality engine on a user terminal. Consequently, additional client-side processing is required, which increases bandwidth usage, processor load, and latency, and can degrade real-time performance in AR-based cosmetic simulation.

Furthermore, many existing solutions process catalog search and generative AI outputs in separate, loosely coupled modules. This separation prevents the computing system from coherently reconciling text-based proposal information returned by a generative AI model with structured product records stored in a database, thereby making it difficult to produce a ranked, machine-readable list of concrete product candidates. In addition, conventional systems do not feed back user emotion and interaction history into the ranking logic or prompt construction logic in a structured manner, resulting in recommendations that are insensitive to the user's current emotional state or evolving preferences.

Accordingly, there is a need for a computer-implemented system that improves how a processor: (i) acquires and normalizes multimodal user data including attributes, preferences, facial features, and emotion; (ii) programmatically constructs and manages prompt sentences for a generative AI model from these structured data; (iii) integrates proposal information returned by the generative AI model with database search results; and (iv) outputs low-level, machine-usable decorative parameters for real-time augmented reality rendering on a user terminal. By improving these specific data processing steps and interactions between the processor, storage circuitry, generative AI model, and terminal, the computing system can reduce client-side computation and network overhead, increase determinism and alignment of generative outputs with stored catalog data, and provide more responsive and technically efficient real-time simulation and recommendation behavior.

The specific processing by the specific processing unit 290 of the data processing device 12 in Application Example 2 is realized by the following means.

The present invention provides a server comprising a processor and a storage unit configured to store catalog information, user-related information, and proposal information, the processor being configured to execute instructions that cause the server to perform operations including: receiving, from a user terminal, attribute information and preference information of a user; generating, by the processor, search conditions corresponding to an image included in the attribute information and the preference information; searching, by the processor, clothing information and merchandise information stored in the storage unit based on the search conditions to extract candidate information; executing, by the processor, image analysis processing on face image data of the user to extract feature quantity data including face shape information and face part information; specifying, by the processor, cosmetic information included in decorative information corresponding to the candidate information based on the feature quantity data; executing, by the processor, emotion analysis processing on at least one of the face image data and expression information of the user to acquire emotion state information; adjusting, by the processor, contents or priorities of the cosmetic information and of the clothing information and the merchandise information included in the candidate information in accordance with the emotion state information; constructing, by the processor, a prompt sentence for causing a generative information processing model to generate a fashion proposal and a cosmetic proposal, based on the attribute information, the preference information, the feature quantity data, and the emotion state information; inputting, by the processor, the prompt sentence into the generative information processing model and acquiring proposal information in a text format from the generative information processing model; analyzing, by the processor, clothing proposal content and cosmetic proposal content included in the proposal information; selecting or re-ranking, by the processor, the clothing information and the merchandise information associated with the candidate information based on an analysis result; generating, by the processor, recommendation result data for presenting the selected or re-ranked clothing information and merchandise information to the user; generating, by the processor, decorative parameters including color attribute information and texture attribute information for each face part based on the cosmetic proposal content and the feature quantity data; and outputting, by the processor, simulation data for superimposed display of a cosmetic state on a face image in real time on the user terminal by using the decorative parameters. This enables the computer system to integrate multimodal user data into a unified, machine-structured prompt sentence for a generative AI model, to automatically reconcile text-based proposal information with catalog records stored in the storage unit, and to directly output low-level rendering parameters consumable by an augmented reality engine on the user terminal, thereby improving computational efficiency, reducing latency and bandwidth, and enhancing the technical performance of real-time fashion and cosmetic recommendation and simulation.

The term “processor” refers to an arithmetic and logic execution element, such as a central processing unit or a processing core, that executes instructions to perform data processing operations including image analysis, emotion analysis, database search, prompt sentence construction, and generation of decorative parameters.

The term “storage unit” refers to a non-transitory information holding element, such as a memory device or a storage medium, configured to store catalog information, user-related information, face feature data, emotion state information, proposal information, and control parameters used by the processor.

The term “attribute information” refers to user-related descriptive data, including demographic attributes, style preferences, and high-level image selections, which represent how the user wishes to appear or be styled.

The term “preference information” refers to user-specific selection data, including favored styles, brands, categories, and other choice indications, that represent the user's likes and dislikes with respect to clothing, cosmetics, and related items.

The term “image” refers to an abstract style or fashion concept, such as a target look or atmosphere, represented by labels or descriptors provided by the user or inferred from user input.

The term “search conditions” refers to query parameters generated by the processor based on attribute information, preference information, and the image, and used to search the storage unit for relevant clothing information and merchandise information.

The term “clothing information” refers to catalog data records relating to wearable items, including item type, style tags, color attributes, size attributes, and associated descriptive metadata stored in the storage unit.

The term “merchandise information” refers to catalog data records relating to goods or services, including clothing, accessories, cosmetics, and other commercial items, with associated attributes such as category, brand, price, and style tags.

The term “candidate information” refers to a subset of clothing information and merchandise information extracted from the storage unit by applying the search conditions, and representing items considered as potential recommendations.

The term “face image data” refers to digital image information that includes at least a user's face region, captured by an imaging device and transmitted to the server for analysis of facial features and emotion.

The term “image analysis processing” refers to computational operations performed on face image data, including detection of a face region, detection of facial landmarks, and extraction of geometric and appearance-based features.

The term “feature quantity data” refers to structured data derived from image analysis processing, including numerical or categorical values that describe facial characteristics such as face shape, position of facial parts, and relative dimensions.

The term “face shape information” refers to part of the feature quantity data that represents the overall contour and geometric classification of the user's face, such as oval, round, or heart-shaped.

The term “face part information” refers to part of the feature quantity data that represents characteristics of individual regions of the face, including eyes, nose, mouth, cheeks, and eyebrows, such as shape, size, and relative position.

The term “decorative information” refers to style and appearance descriptors applicable to visual modification of a face or body, including cosmetic styles, color schemes, and textural effects associated with clothing or cosmetics.

The term “cosmetic information” refers to a subset of decorative information relating specifically to makeup items, colors, placement, and application styles that can be applied to facial regions.

The term “emotion analysis processing” refers to computational operations that estimate a user's emotional state from face image data or expression information by applying recognition models or scoring functions to derive emotion labels and intensities.

The term “expression information” refers to observable data indicating the user's expressive state, including facial expressions, textual expressions, or voice-derived emotion cues used to infer emotion state information.

The term “emotion state information” refers to structured data indicating a user's emotional condition, such as joy, sadness, anger, or excitement, together with optional intensity values or confidence scores.

The term “prompt sentence” refers to a natural language instruction string constructed by the processor, which encodes user attributes, preferences, facial features, and emotion state information, and is input to a generative information processing model to elicit a desired output.

The term “generative information processing model” refers to a computational model, such as a generative AI model, trained to produce output information in response to an input prompt sentence, including text-based proposals for fashion and cosmetic recommendations.

The term “proposal information” refers to text or structured data generated by the generative information processing model in response to the prompt sentence, including clothing proposal content, cosmetic proposal content, and product-related suggestions.

The term “fashion proposal” refers to descriptive content within the proposal information that suggests outfits, styles, and combinations of clothing and accessories aligned with the user's image and preferences.

The term “cosmetic proposal” refers to descriptive content within the proposal information that suggests makeup items, colors, and application methods adapted to the user's facial features and emotion state.

The term “clothing proposal content” refers to portions of the proposal information that describe recommended clothing types, styles, colors, and combinations intended to be worn by the user.

The term “cosmetic proposal content” refers to portions of the proposal information that describe recommended makeup styles, including eye makeup, cheek color, and lip color, and their placement on facial regions.

The term “analysis result” refers to structured output derived from processing the proposal information, including parsed lists of suggested items, attributes, and relationships used to refine candidate information.

The term “recommendation result data” refers to data generated by the processor that defines a ranked or filtered set of clothing information and merchandise information selected for presentation to the user, based on candidate information and proposal information.

The term “decorative parameters” refers to machine-readable values specifying how cosmetic effects should be rendered on different face parts, including color attribute information, texture attribute information, and region identifiers.

The term “color attribute information” refers to data elements representing color values for visual rendering, such as color codes, opacity levels, and blending parameters for makeup or clothing overlays.

The term “texture attribute information” refers to data elements representing surface appearance characteristics, such as glossiness, matte finish, or patterning, for rendering cosmetic or clothing effects in a graphical environment.

The term “simulation data” refers to data transmitted from the server to a user terminal that encodes decorative parameters and control information, enabling the user terminal to superimpose a cosmetic state on a face image in real time.

The term “user terminal” refers to an endpoint computing device, such as a mobile device, wearable device, or personal computer, that captures user input and face images, displays recommendation result data, and executes augmented reality rendering based on simulation data.

The term “augmented reality processing” refers to a rendering process on the user terminal that combines real-world image data, such as camera images, with computer-generated visual elements, including cosmetic overlays, to form a composite display.

The term “product type information” refers to generalized identifiers within the proposal information that indicate categories or classes of merchandise, such as dresses, lipsticks, or accessories, without specifying a particular catalog item.

The term “style information” refers to descriptors within the proposal information or catalog records that characterize the aesthetic or fashion style of items, such as casual, elegant, or modern.

The term “product candidates” refers to specific catalog items identified by collating product type information and style information in the proposal information with merchandise information stored in the storage unit.

The term “product list information” refers to structured data representing an ordered list of product candidates, including identifiers and associated attributes, prioritized according to emotion state information and preference information.

In one embodiment, a server cooperates with a terminal operated by a user to execute a fashion and cosmetic recommendation system. The server includes a processor and a storage unit. The storage unit includes a catalog database, a user profile database, and a log database. The processor executes software modules implemented, for example, in a high-level programming language running on an operating system. The terminal includes an imaging device, a display unit, an input interface, and a communication interface. The terminal executes an application implemented, for example, using a cross-platform framework.

The terminal captures a face image of the user. The terminal uses a camera module of the terminal hardware and an operating system camera API to acquire image frames. The terminal compresses the captured face image into a raster image format and attaches metadata such as a terminal identifier and a timestamp. The terminal transmits the face image and user input data to the server through a network using a secure communication protocol.

The user provides attribute information and preference information through the terminal. The user selects one or more style labels such as “elegant” or “casual”, and the user optionally enters textual preference information such as favored brands or general comments. The terminal converts the user's selections and textual input into a structured data object containing style labels and free-text fields and transmits this object to the server.

The server stores the received face image and input data into the storage unit. The server associates the face image data with the attribute information and the preference information. The server normalizes the textual input into internal representations. The server uses a natural language processing library, for example a tokenization and entity recognition library, to identify style terms and brand terms in the textual input. The server maps each recognized term to a canonical style code and a canonical brand code. The server writes these codes into the user profile database as standardized attributes.

The server performs image analysis processing on the face image data. The server uses an image processing library such as a convolutional neural network implemented using a numerical computation framework to detect a face region and facial landmarks. The server uses multiple convolutional layers, non-linear activation functions, pooling layers, and fully connected layers to output landmark coordinates and classification labels. The server uses a pre-trained face detection model and a separate face landmark model, each trained on large annotated image datasets by minimizing a loss function such as mean squared error for landmark regression and cross-entropy for classification of face shape categories.

The server converts the detected landmarks into feature quantity data. The server computes distances and ratios between landmark coordinates to derive measures such as eye width, nose width, mouth width, and jawline curvature. The server maps these measures to discrete categories for face shape information and face part information. The server stores the feature quantity data as a structured vector in the user profile database. The server uses a specific data schema that stores, for each face, numerical indices for eye shape, lip fullness, skin tone cluster, and other attributes.

The server executes emotion analysis processing on the face image data or expression information. The server applies an emotion recognition neural network that uses an architecture such as a convolutional backbone followed by recurrent or attention layers to model expression patterns. The server feeds normalized face crops into the emotion network and obtains scores for multiple emotion classes. The server converts the scores into emotion state information by selecting the class with highest probability and recording its probability as intensity. The server stores the emotion state information in association with the current session.

The server generates search conditions for retrieving candidate items from the catalog database. The server uses the standardized style codes and brand codes derived from the attribute information and the preference information. The server translates user-friendly labels into query keys and filters that are compatible with the schema of clothing information and merchandise information. For example, the server maps “elegant” to a set of catalog attributes that indicate garment silhouettes, colors, and materials suitable for an elegant style. The server constructs composite query conditions that combine style codes, category filters, and possibly price and availability constraints.

The server searches the storage unit using the search conditions. The server issues structured queries against the catalog database. The server retrieves a set of clothing records and merchandise records that satisfy the search conditions. The server constructs candidate information as a collection of references to these records, with references including unique product identifiers and associated feature fields. The server stores the candidate information temporarily in memory.

The server specifies cosmetic information based on the feature quantity data and the candidate information. The server maintains a cosmetic rule base that maps facial feature patterns and target style labels to recommended cosmetic styles. The server combines the face shape information and face part information with the user's selected style codes. The server uses either a rule-based classifier or a smaller neural network to output initial cosmetic parameters such as recommended eye makeup type, cheek color family, and lip color family.

The server adjusts contents and priorities of the cosmetic information and of the candidate information based on the emotion state information. The server uses a control logic module that maps emotion classes to preference adjustments. For example, the server increases the weight of bright color families when the emotion state information indicates a joyful or excited state, and the server increases the weight of soft, neutral tones when the emotion state information indicates a sad or tired state. The server applies these weights to both cosmetic suggestions and catalog item rankings by modifying ranking scores before selection. By operating directly on numerical scores used by the ranking algorithm, the server reduces the need for repeated database access and reduces processing time.

The server constructs a prompt sentence for a generative AI model based on the attribute information, the preference information, the feature quantity data, and the emotion state information. The server concatenates structured segments into a natural language string using a deterministic template. The server uses different templates depending on whether the request is for a fashion proposal, a cosmetic proposal, or a combined proposal. The server encodes, within the prompt sentence, the style codes, facial feature descriptions, and emotion labels in a consistent syntax so that the generative AI model can reliably interpret them.

The server may use, as examples of prompt sentences, the following text strings: “Face features: large eyes and bright skin. Based on these features, please propose suitable makeup in a cute style.”

“The user has almond-shaped eyes and olive skin and seems depressed. Please propose bright, uplifting makeup that suits these features.”

“The user prefers an elegant style and likes a specific brand. Please propose several outfits and accessories that match an elegant fashion image.”

“The user has selected an elegant style and feels joy. Based on this, please propose an elegant outfit, matching makeup, and a list of suitable product types.”

The server inputs the prompt sentence into a generative AI model. The server uses an application programming interface of a generative information processing model implemented as a large language model. The generative AI model includes multiple transformer layers with self-attention, feed-forward sublayers, and layer normalization. The generative AI model has been trained on large corpora of text using an objective function such as cross-entropy loss for next-token prediction. During inference, the server feeds the prompt sentence as a sequence of tokens into the generative AI model and obtains a sequence of output tokens representing proposal information.

The server controls the inference behavior of the generative AI model by setting parameters such as temperature, maximum token count, and sampling strategy. The server can use reduced temperature and constrained decoding to improve determinism and alignment with internal data. The server receives the proposal information as text and parses it using a text parser. The server recognizes patterns in the proposal information, such as bullet lists or key phrases, and segments the text into clothing proposal content, cosmetic proposal content, and product type information.

The server aligns the proposal information with catalog entries. The server maps generic item descriptions in the clothing proposal content and the cosmetic proposal content to structured catalog attributes. The server uses a keyword mapping table and, optionally, an embedding-based similarity search method to match descriptive terms in the proposal information to catalog fields. The server selects concrete product candidates by matching style information and product type information to catalog fields. The server updates ranking scores of these product candidates using the emotion state information and preference information, and then generates product list information as an ordered list of items.

The server generates decorative parameters based on the cosmetic proposal content and the feature quantity data. The server translates cosmetic descriptors such as “soft brown eyeliner”, “pink blush”, and “glossy coral lip” into numeric color codes, opacity values, and texture identifiers. The server associates each set of decorative parameters with a specific face part, using the locations and sizes of facial features derived from the feature quantity data. The server produces a data structure that specifies, for each face part, a color attribute vector and a texture attribute vector.

The server outputs simulation data that contains decorative parameters and control information to the terminal. The server formats the simulation data as a structured message including, for each face part, rendering parameters and timing flags. The server transmits the simulation data across the network to the terminal using an efficient, compressed format. By sending low-level rendering parameters instead of full rendered images, the server reduces bandwidth usage and offloads some rendering computation to the terminal while still centralizing heavy inference tasks on the server.

The terminal receives the simulation data and performs augmented reality processing. The terminal uses an augmented reality framework that provides real-time face tracking and overlay capabilities. The terminal applies the decorative parameters to shader programs and texture mapping routines that run on a graphics processing unit of the terminal. The terminal overlays the cosmetic state onto the live camera image of the user's face in real time. The terminal uses the facial landmark tracking in combination with the region identifiers from the simulation data to correctly place and deform the overlays according to head pose and facial expression.

The terminal displays the recommendation result data. The terminal renders a list of clothing items and merchandise items, with images and textual descriptions derived from the recommendation result data. The terminal also shows an interactive interface that allows the user to inspect each item and, optionally, to select or deselect items. The terminal may display, in parallel, the augmented reality view so that the user can simultaneously see fashion recommendations and cosmetic simulations.

The server records user interactions and uses them to improve future processing. The server stores explicit feedback, such as items added to favorites or items ignored, into the user profile database. The server updates the preference information by adjusting weights associated with style codes and product attributes. The server also adjusts future prompt sentences by including statements such as “The user prefers natural makeup and avoids heavy eyeliner.”. By incorporating structured preferences into the prompt sentence, the server drives the generative AI model toward recommendations that better align with the user's history.

The described architecture improves computer performance in several ways. The server separates heavy neural network computations for face analysis, emotion analysis, and language generation from lighter terminal-side rendering computations. The server reduces round-trip latency by pre-structuring feature quantity data and emotion state information and by generating concise simulation data for augmented reality. The server improves accuracy of recommendations by using a coordinated pipeline that links standardized feature representations with generative proposals and with catalog records. The server improves data management by storing all intermediate feature vectors, emotion states, prompt sentences, and generative outputs in explicit, indexed structures so that subsequent queries can reuse prior computations.

The server uses machine learning methods with specific architectures and learning methods.

The server trains the face analysis networks and emotion analysis networks using supervised learning on labeled datasets. The server minimizes loss functions such as mean squared error for landmark regression and categorical cross-entropy for emotion classification. The server uses stochastic gradient descent or a variant such as Adam to update network weights. The server optionally uses data augmentation techniques such as random cropping, rotation, and brightness adjustment to improve robustness. The server stores trained model parameters in the storage unit and loads them into memory for inference.

The server uses non-conventional processing order and combination rules that differ from simple human workflows. The server always transforms raw inputs into normalized feature vectors before constructing any prompt sentence. The server always reconciles proposal information with catalog data through a structured matching algorithm rather than presenting unstructured text directly. The server always converts cosmetic descriptions into explicit rendering parameters instead of leaving that task to an operator. These non-conventional steps, implemented as deterministic algorithms and data flows, lead to improved consistency, reduced error rate in mapping generative outputs to catalog items, and reduced processing time for rendering.

In another embodiment, the server uses an alternative generative AI model architecture such as a sequence-to-sequence transformer with encoder-decoder structure. The server can use different prompt construction templates tailored to the specific generative AI model. In a further embodiment, the server uses a hybrid recommendation mechanism that combines similarity search over feature embeddings with rule-based filtering before generating the prompt sentence. In still another embodiment, the server executes part of the image analysis processing on the terminal and transmits only feature quantity data to the server, thereby reducing the amount of image data sent across the network.

In each embodiment, the server integrates multimodal data and multiple algorithms into a unified pipeline. The server improves processing speed by reusing feature quantity data and emotion state information across multiple queries and by reducing redundant model calls. The server improves precision by combining numerical feature vectors with natural language prompt sentences in a controlled way. The server reduces communication load by transmitting compressed feature and parameter data rather than raw or rendered images. These technical effects arise from the specific system configuration, data structures, and processing sequences, rather than from a mere automation of human decision-making.

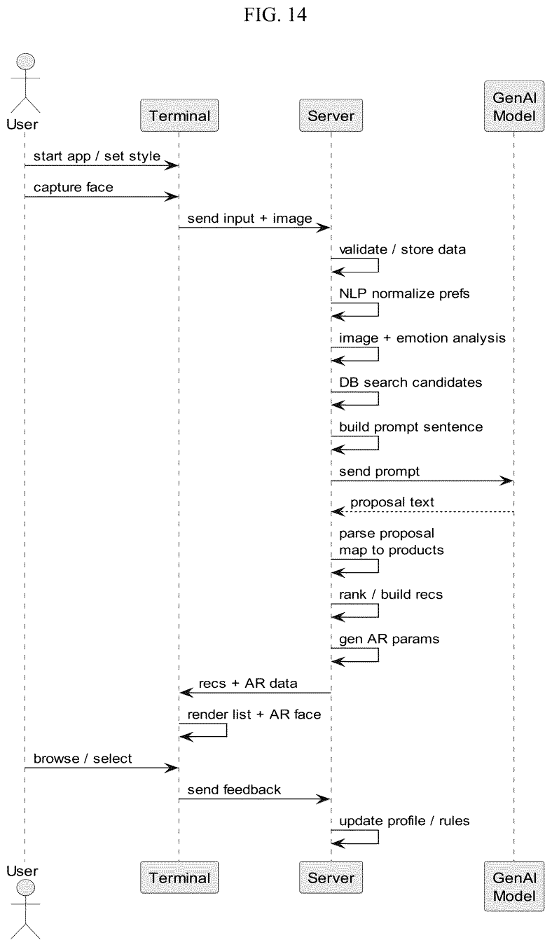

The following describes the processing flow using FIG. 14.

### Step 1:

User operates the terminal to launch an application and provide initial inputs.

User selects at least one style label (for example, “elegant”, “casual”, or “cute”) and optionally inputs free-text preference information such as favored brands or a desired occasion. The input is user interaction events (taps, text entries). The output is structured user input data, in which the terminal converts the raw events into a data structure containing style labels and textual preference fields.

### Step 2:

Terminal acquires face image data from an imaging device.

Terminal activates a camera module, displays a preview, and captures a frame containing the user's face when the user confirms. The input is sensor data from the imaging device. The terminal compresses this sensor data into a digital image format and appends metadata such as a timestamp and device identifier. The output is face image data with associated metadata stored in terminal memory.

### Step 3:

Terminal transmits user input data and face image data to the server.

Terminal packages the structured user input data and the face image data into a request and sends it via a communication interface using a secure protocol. The input is the in-memory structured user input and the compressed face image. The terminal performs data serialization and encryption, then transmits the resulting byte sequence. The output is a network message that reaches the server.

### Step 4:

Server receives and validates the transmitted data.

Server accepts the network message, separates the user input data and the face image data, and checks formats, sizes, and required fields. The input is the received network message.

The server decodes the serialized structures, verifies that the image is within allowable size limits and that mandatory user fields are present. The output is validated user input data and validated face image data stored in server memory.

### Step 5:

Server stores the raw data into a storage unit.

Server writes the face image data to a persistent storage area and records its location, timestamp, and a session identifier in a database. The input is validated face image data and metadata. The server performs an insert operation into a catalog of user sessions and stores a path or identifier for the image. The output is a stored record that links the image identifier with the current user session and input attributes.

### Step 6:

Server normalizes attribute information and preference information.

Server processes free-text preference fields using a natural language processing module to extract style terms and brand terms. The input is textual preference information and style labels. The server tokenizes the text, applies term matching or entity recognition, and maps each recognized term to a canonical code. The output is normalized attribute information and preference information represented as standardized style codes and brand codes.

### Step 7:

Server generates search conditions for catalog retrieval.

Server converts the normalized style codes and brand codes into search filters that match the schema of the catalog database. The input is the set of standardized codes. The server applies mapping rules that assign database field names and acceptable values (for example, mapping “elegant” to a set of allowed silhouettes, colors, and materials). The output is a search condition structure that can be directly translated to database queries.

### Step 8:

Server retrieves candidate clothing information and merchandise information.

Server executes database queries against a catalog table using the search condition structure. The input is the search conditions. The server performs selection and join operations on catalog records to identify items whose attributes match the conditions. The output is candidate information, consisting of a list of product identifiers and their associated fields loaded into server memory.

### Step 9:

Server performs image analysis processing on the face image data.

Server passes the face image data through a face detection and landmark extraction model. The input is the stored face image. The server runs convolution operations, non-linear activations, and pooling to detect a face region and derive facial landmarks. The output is a set of landmark coordinates and preliminary classification results for face shape stored as feature quantity data.

### Step 10:

Server derives face shape information and face part information from landmarks.

Server computes geometric measures such as distances, angles, and ratios between landmark coordinates. The input is the set of landmark coordinates. The server applies mathematical operations to derive metrics like eye width relative to face width or curvature of the jawline, then classifies these metrics into discrete categories. The output is a structured set of face shape information and face part information added to the feature quantity data vector.

### Step 11:

Server executes emotion analysis processing on the face image data.

Server feeds a normalized face crop into an emotion classification model. The input is the face region obtained from the image analysis. The server performs a forward pass through the model to obtain probabilities for multiple emotion classes and then selects a dominant class with associated intensity. The output is emotion state information containing an emotion label and a numeric intensity value.

### Step 12:

Server specifies initial cosmetic information based on facial features and style.

Server combines the feature quantity data with the normalized style codes to obtain an initial cosmetic style profile. The input is face shape information, face part information, and style codes. The server applies rule-based logic or a lightweight classification model to map patterns (for example, large eyes plus elegant style) to cosmetic categories such as eyeliner type, blush zone, and lip color family. The output is initial cosmetic information structured as recommended cosmetic types and general color families.

### Step 13:

Server adjusts cosmetic information using emotion state information.

Server modifies the initial cosmetic profile in accordance with the user's emotion state. The input is the initial cosmetic information and emotion state information. The server applies weighting factors that shift intensity or color direction (for example, increasing brightness and saturation for joyful states). The output is adjusted cosmetic information that reflects both facial features and emotional context.

### Step 14:

Server adjusts ranking of candidate items using emotion state information and preference information.

Server recalculates ranking scores for each candidate item. The input is candidate information, preference information, and emotion state information. The server computes a base relevance score from style and brand matches and then applies emotion-dependent multipliers (for example, favoring newer or more vibrant items for excited states). The output is a re-ranked candidate item list with updated scores.

### Step 15:

Server constructs a prompt sentence for a generative AI model.

Server assembles a natural language string encoding user attributes, facial features, emotion state, and desired output type. The input is normalized attribute information, preference information, feature quantity data, and emotion state information. The server formats these into a structured description according to a template, inserting specific phrases for style and feature descriptions. The output is a prompt sentence ready to be consumed by the generative AI model.

### Step 16:

Server transmits the prompt sentence to the generative AI model and obtains proposal information.

Server sends the prompt sentence to an external or internal generative AI model via an application programming interface. The input is the prompt sentence. The server encodes it as tokens, requests inference with controlled parameters, and receives a sequence of output tokens. The output is proposal information in a text format containing clothing proposal content, cosmetic proposal content, and generic product type information.

### Step 17:

Server parses the proposal information into structured components.

Server analyzes the text to separate sections corresponding to outfits, cosmetics, and product types. The input is the text proposal information. The server uses pattern matching, token segmentation, and rule-based parsing to detect list structures and key descriptors. The output is structured proposal components that can be individually processed.

### Step 18:

Server maps clothing proposal content to catalog attributes and product candidates.

Server extracts descriptive terms such as item types, styles, and colors from the clothing proposal content. The input is parsed clothing proposal content. The server maps descriptive terms to catalog attribute fields via a term-to-attribute mapping table and, where needed, a similarity calculation over text embeddings. The output is a set of product candidates that align with the generative AI model's text suggestions.

### Step 19:

Server maps cosmetic proposal content to detailed cosmetic attributes.

Server identifies eye, cheek, and lip descriptors in the cosmetic proposal content. The input is parsed cosmetic proposal content. The server interprets expressions such as “soft brown eyeliner” or “glossy coral lip” by mapping them to numeric color codes, finish types, and application zones. The output is a refined cosmetic attribute structure that can be transformed into rendering parameters.

### Step 20:

Server combines generative AI-based candidates with database-derived candidates.

Server reconciles items suggested through proposal mapping with items obtained from the initial search of the catalog. The input is the re-ranked candidate item list and the mapped product candidates from the proposal content. The server merges, deduplicates, and adjusts ranking scores based on both database relevance and generative AI relevance. The output is a final candidate set used to build recommendation result data.

### Step 21:

Server generates recommendation result data for presentation.

Server selects top-ranked items and formats them for display. The input is the final candidate set with scores. The server converts each selected item into a display record including identifiers, names, styles, prices, and image references. The output is recommendation result data comprising an ordered list of clothing information and merchandise information for the user.

### Step 22:

Server generates decorative parameters from cosmetic attributes and facial features.

Server calculates per-region rendering parameters by combining the refined cosmetic attributes with geometric information from the feature quantity data. The input is cosmetic attribute structure and feature quantity data. The server associates each cosmetic layer with a target region mask and assigns color vectors, opacity values, and texture identifiers based on cosmetic descriptors and facial geometry. The output is decorative parameters for each face part.

### Step 23:

Server composes simulation data for augmented reality rendering.

Server packages decorative parameters together with control flags and region identifiers into a compact structure for the terminal. The input is the set of decorative parameters. The server organizes them by face region and ensures each parameter set includes all information needed by the terminal's rendering engine. The output is simulation data that defines how the cosmetic state should be superimposed on live camera images.

### Step 24:

Server transmits recommendation result data and simulation data to the terminal.

Server sends a response message containing both textual recommendation result data and simulation data. The input is the recommendation result data and the simulation data. The server serializes these structures, applies any required compression, and transmits them via the communication interface. The output is a network response received by the terminal.

### Step 25:

Terminal renders recommendation result data on the display.

Terminal receives the response and decodes the recommendation result data. The input is the response message from the server. The terminal maps product image references to visual components, arranges items into lists or grids, and draws item names and prices on the screen. The output is a graphical user interface presenting the recommended clothing and merchandise items.

### Step 26:

Terminal performs augmented reality processing using simulation data.

Terminal reads the decorative parameters and control information from the simulation data. The input is simulation data and live camera frames. The terminal uses a face tracking module to detect facial landmarks and uses these to align rendering regions with the user's face. The terminal applies shader operations and texture mapping using the decorative parameters to overlay cosmetic effects. The output is a composite video stream in which the cosmetic state is superimposed on the user's face in real time.

### Step 27:

User interacts with the displayed recommendations and AR view.

User browses the recommended items and observes the cosmetic simulation. The input is the visual output from the terminal. The user taps items to view more details, scrolls through lists, and decides which suggestions are attractive. The output is user interaction signals that indicate interest, selections, or dismissals.

### Step 28:

Terminal transmits user interaction feedback to the server.

Terminal captures user actions such as item selections, favorites, or ignored items. The input is the interaction events on the interface. The terminal aggregates them into feedback records and transmits them to the server. The output is feedback data that indicates user responses to particular items.

### Step 29:

Server updates user preference information and future processing parameters.

Server receives the feedback data and modifies stored preference weights and prompt construction parameters. The input is feedback records associated with specific items and actions. The server adjusts numerical weights in the user profile to reinforce preferred styles and reduce weight on rejected styles. The output is an updated user profile and updated rules for future search conditions and prompt sentence construction.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

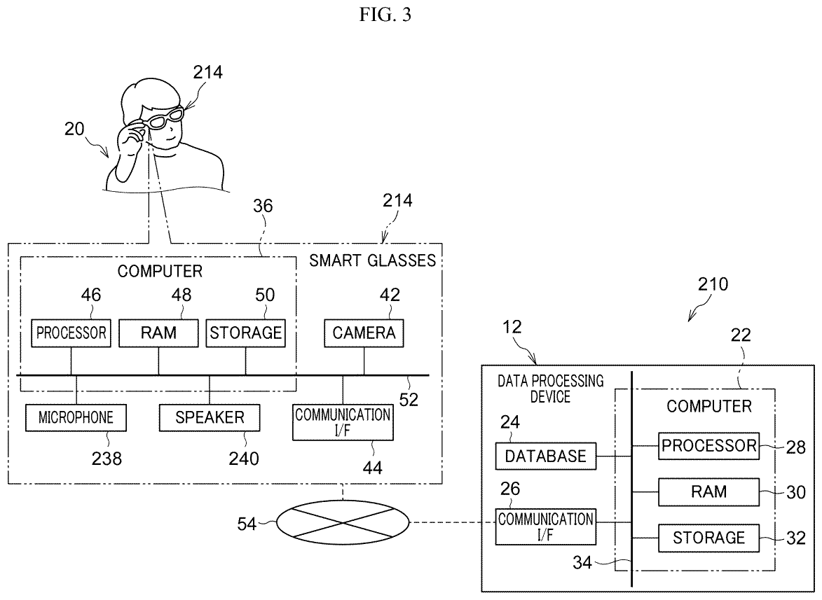

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

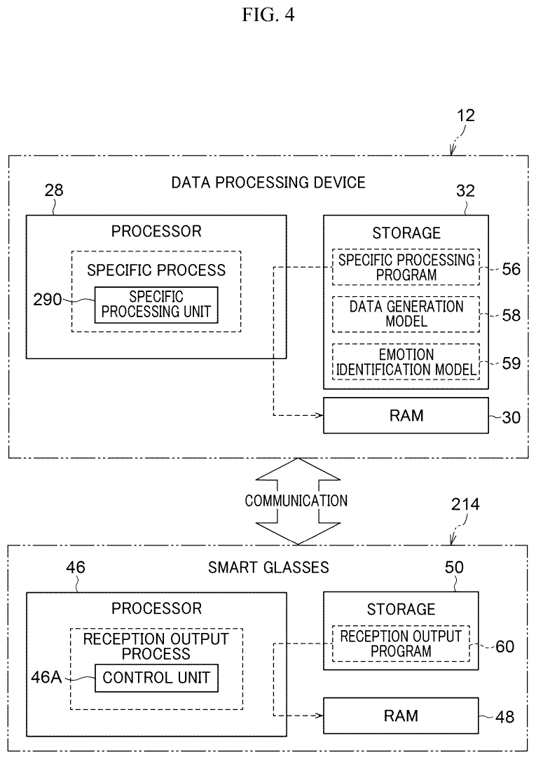

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

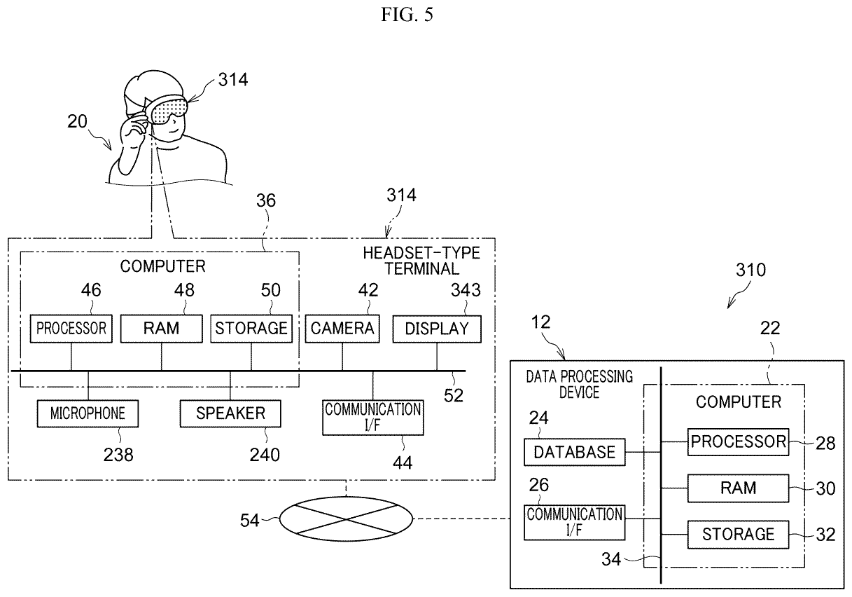

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

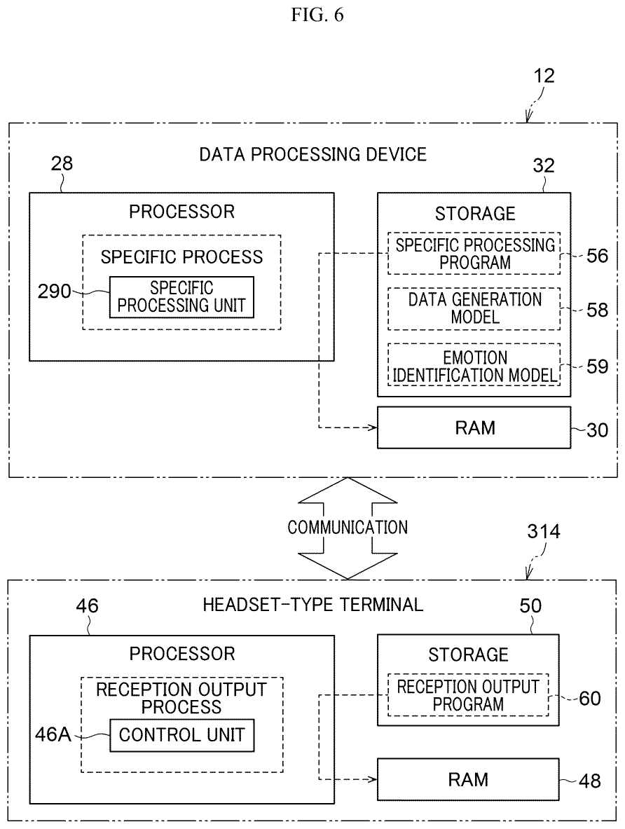

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

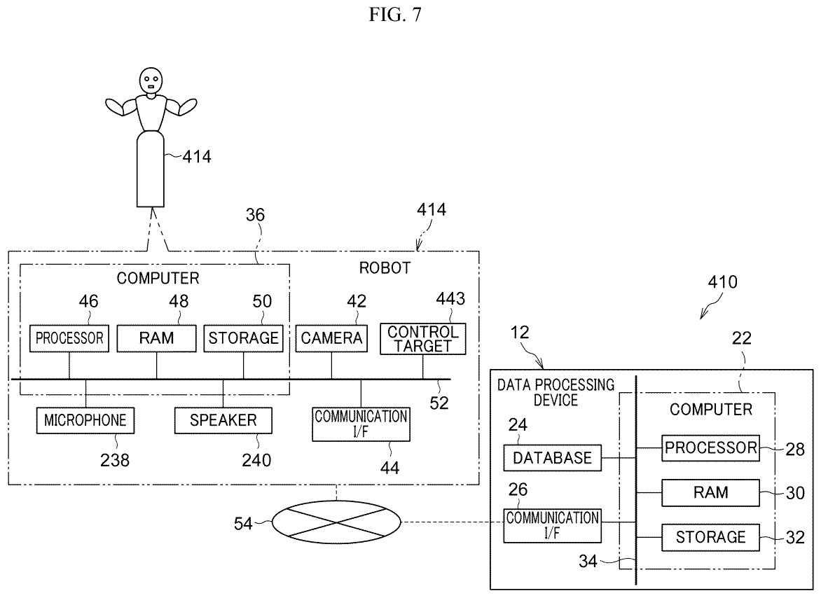

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

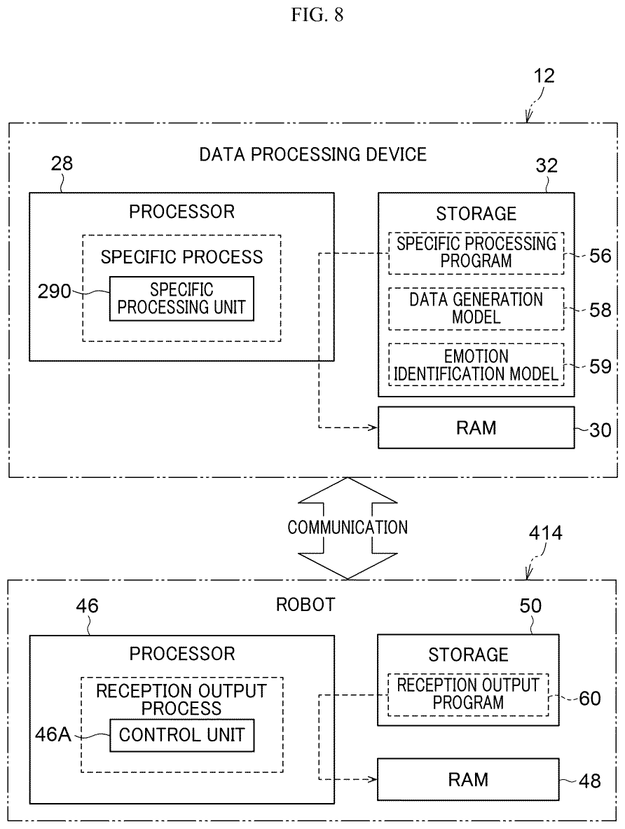

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

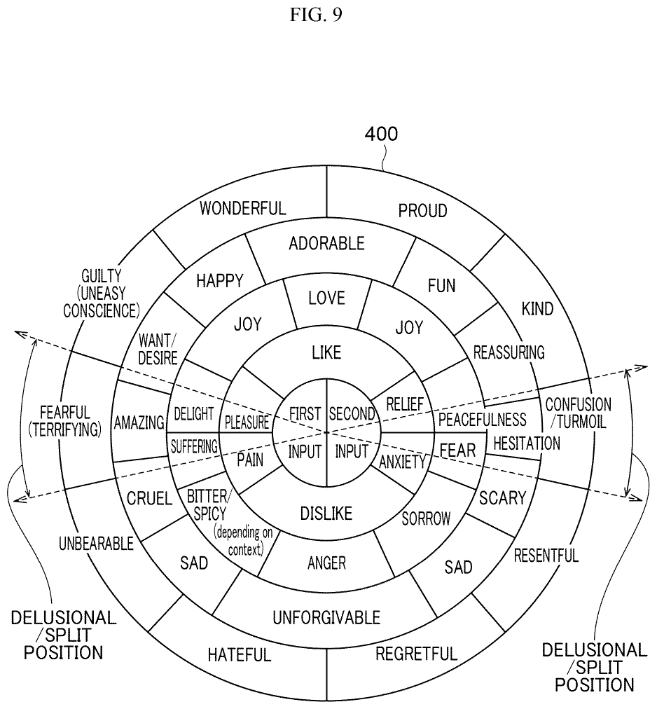

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

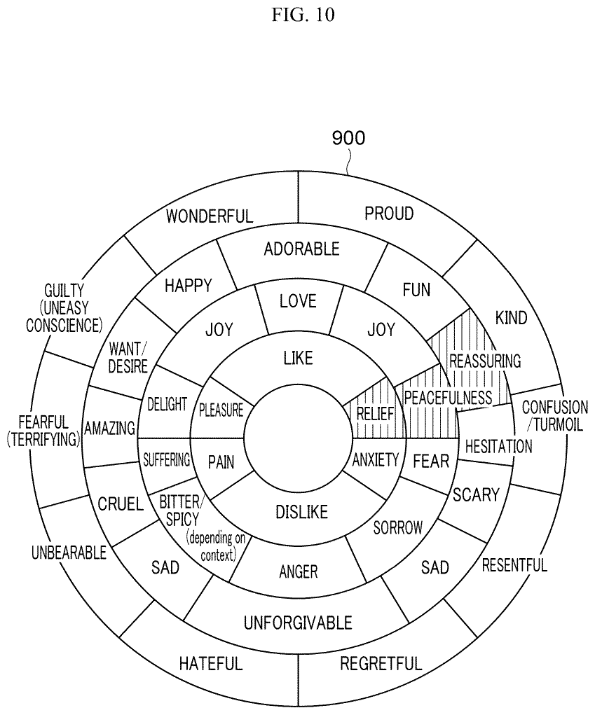

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### Supplementary 1

A system comprising a processor,
wherein the processor is configured to
acquire, from a communication terminal, user preference information and a face image of a user, and normalize image information included in the user preference information into a higher-level category to determine a style attribute, and
generate a prompt sentence, based on the style attribute and the user preference information, the prompt sentence instructing a generative AI model to generate a style proposal, and cause the generative AI model to perform text generation processing using the prompt sentence as input to obtain style proposal information as output, and
perform image preprocessing and feature extraction processing on the face image to generate feature data representing shape features and color features of a face, and generate makeup method proposal information corresponding to the style proposal information based on the feature data and the style proposal information, and
store, as structured data, the style proposal information and the makeup method proposal information in association with each other, and transmit response data including the style proposal information and the makeup method proposal information toward the communication terminal, and
acquire, via the communication terminal, additional conditions from the user regarding the style proposal information and the makeup method proposal information, generate an update prompt sentence reflecting the additional conditions, and input the update prompt sentence into the generative AI model to obtain updated style proposal information and updated makeup method proposal information.

### Supplementary 2

The system according to supplementary 1,
wherein the processor is configured to
associate, in the response data, feature data for each facial region extracted from the face image with corresponding elements of the makeup method proposal information, such that the makeup method proposal information is presentable on the communication terminal in association with respective regions on the face image.

### Supplementary 3

The system according to supplementary 1,
wherein the processor is configured to
generate, based on the style attribute and the style proposal information, a prompt sentence for the generative AI model to extract recommendation target information including product categories other than clothing, and add recommendation target information conforming to the style proposal information, based on a generation result of the generative AI model, to be presented to the user.

### Application Example 1

### Supplementary 1

A system comprising a processor,
wherein the processor is configured to
receive, from a user terminal via a communication network, input information from a user including information regarding an abstract reference object, an abstract style, or an abstract preference, convert the input information into structured information, and store the structured information in a storage unit,
select a prompt sentence template representing an appearance concept desired by the user on the basis of the structured information, replace at least one variable portion in the template with the abstract reference object, the abstract style, or the abstract preference included in the structured information, and thereby generate a concrete prompt sentence that instructs generation of a fashion proposal by a generative AI model,
transmit the generated prompt sentence to a generative AI model of a natural language processing type disposed externally or internally, analyze natural language text acquired from the generative AI model to extract merchandise attribute information including clothing attributes, accessory attributes, and usage-situation attributes, search, on the basis of the merchandise attribute information, product information stored in a product information storage unit, and generate recommendation product information to be presented to the user, analyze face image data transmitted from the user by an image processing algorithm to extract face-shape attributes, color-tone attributes, and part attributes, generate structured face-attribute information in which the extracted face attributes are associated with the recommendation product information, generate a cosmetic prompt sentence that instructs generation of a cosmetic proposal by the generative AI model on the basis of the structured face-attribute information and the recommendation product information, acquire natural language text on the basis of the cosmetic prompt sentence from the generative AI model, and generate cosmetic proposal information to be presented to the user by extracting cosmetic process information and cosmetic product-attribute information from the natural language text, and
convert the recommendation product information and the cosmetic proposal information into user-interface data, transmit the user-interface data to the user terminal, and enable, in a virtual purchase environment, an operation in which the user selects a product related to the recommendation product information and performs a trial or purchase process.

### Supplementary 2

The system according to supplementary 1,
wherein the processor is configured to
select the prompt sentence template, in generating the prompt sentence, from a plurality of template groups in accordance with a type and content of the input information, and arrange, in a hierarchical manner, a keyword regarding the abstract style, a keyword regarding the abstract reference object, and a keyword regarding a usage situation in the prompt sentence so as to acquire, from the generative AI model, a plurality of proposal candidates having a hierarchical structure.

### Supplementary 3

The system according to supplementary 1,
wherein the processor is configured to
cause at least a part of the recommendation product information and at least a part of the cosmetic proposal information to be superimposed and displayed, by a virtual trial display unit operating on the user terminal, on an image of the user or on a virtual body model, and iteratively execute generation of the prompt sentence, inference by the generative AI model, and updating of the recommendation product information in response to an operation of the user so as to dynamically update proposal content in accordance with a change in a preference of the user.

### EXAMPLE 2

### Supplementary 1

A system comprising a processor,
wherein the processor is configured to
acquire, from a terminal operated by a user, a person image selected by the user, detect a face region from the person image, preprocess the person image, and convert the person image into structured image data,
detect facial feature points from the structured image data by using an image processing program, calculate numerical feature data including feature values related to skin color, eye shape, lip shape, and face contour by using a machine learning program,
convert the numerical feature data into an appearance description in natural language based on predetermined correspondence rules, and automatically generate a prompt sentence to be input to a generative artificial intelligence model by combining the appearance description with style information input by the user,
transmit the prompt sentence to an external generative artificial intelligence model and receive, from the external generative artificial intelligence model, text data or image data including a cosmetic proposal corresponding to the appearance description and the style information, and
convert the text data or the image data into display data suitable for viewing on the terminal and transmit the display data to the terminal.

### Supplementary 2

The system according to supplementary 1,
wherein the processor is configured to
generate the cosmetic proposal as structured data in which recommended colors, textures, and application procedures are divided for each region including base makeup, eye makeup, cheek makeup, and lip makeup, and transmit the structured data to the terminal.

### Supplementary 3

The system according to supplementary 1,
wherein the processor is configured to
search a storage device storing clothing-related information based on the numerical feature data and the style information, select clothing candidates consistent with the cosmetic proposal, and include information on the clothing candidates in the display data.

### Application Example 2

### Supplementary 1

A system comprising a processor and a storage unit,
wherein the processor is configured to
receive attribute information and preference information obtained from a user, generate search conditions corresponding to an image included in the attribute information and the preference information, and, based on the search conditions, search clothing information and merchandise information stored in the storage unit to extract candidate information; and
execute image analysis processing on face image data obtained from the user to extract feature quantity data including face shape information and face part information, and specify cosmetic information included in decorative information corresponding to the candidate information based on the feature quantity data; and
execute emotion analysis processing on the face image data or expression information obtained from the user to acquire emotion state information, and adjust contents or priorities of the cosmetic information and the clothing information and the merchandise information included in the candidate information in accordance with the emotion state information; and construct a prompt sentence for causing a generative information processing model to generate a fashion proposal and a cosmetic proposal, based on the attribute information, the preference information, the feature quantity data, and the emotion state information, input the prompt sentence into the generative information processing model, and acquire proposal information in a text format from the generative information processing model; and analyze clothing proposal content and cosmetic proposal content included in the proposal information, select or re-rank the clothing information and the merchandise information associated with the candidate information based on an analysis result, and generate recommendation result data for presenting the selected or re-ranked clothing information and merchandise information to the user; and
generate decorative parameters including color attribute information and texture attribute information for each face part based on the cosmetic proposal content and the feature quantity data, and output simulation data for superimposed display of a cosmetic state on a face image in real time on a user terminal by using the decorative parameters.

### Supplementary 2

The system according to supplementary 1,
wherein the processor is configured to output the simulation data generated based on the decorative parameters as control information for performing augmented reality processing for displaying a moving image on the user terminal, and to cause the user terminal to superimpose the cosmetic state on a camera image in real time.

### Supplementary 3

The system according to supplementary 1,
wherein the processor is configured to, when generating the recommendation result data, collate product type information and style information included in the proposal information acquired from the generative information processing model with the merchandise information stored in the storage unit to specify concrete product candidates, and assign priorities to the product candidates based on the emotion state information and the preference information to generate product list information.

What is claimed is:

1. A system comprising:
circuitry configured to:
receive, via a communication interface coupled to a packet-switched network, first input data and image data from a terminal device;
search, based on the first input data, a storage device to retrieve a set of item records matching the first input data;
process the image data through a trained neural network model to generate a feature vector representing a plurality of attributes extracted from the image data;
generate, based on the feature vector and the set of item records, second output data associated with the set of item records;
construct, based on at least the first input data, an instruction sequence for a generative neural network model, transmit the instruction sequence to the generative neural network model, and acquire generated text data responsive to the instruction sequence; and
transmit response data comprising the generated text data and the second output data to the terminal device via the communication interface.

2. The system according to claim 1, wherein the circuitry is further configured to detect a region of interest within the image data, crop the image data to the region of interest, and normalize the cropped image data into a multidimensional tensor prior to processing the image data through the trained neural network model.

3. The system according to claim 2, wherein the trained neural network model comprises a convolutional neural network including a plurality of convolutional layers, at least one pooling layer, and at least one fully connected layer, and the feature vector comprises coordinate data representing a plurality of landmark positions detected within the region of interest.

4. The system according to claim 3, wherein the circuitry is further configured to compute, from the coordinate data, geometric measures including at least one of a distance ratio, an angle, or a curvature index between landmark positions, and classify the geometric measures into categorical shape labels representing facial shape attributes and facial part attributes.

5. The system according to claim 4, wherein the circuitry is further configured to sample pixel values from sub-regions of the image data identified by the landmark positions, compute color distribution statistics from the sampled pixel values, and classify the color distribution statistics into categorical color labels representing skin tone and undertone attributes.

6. The system according to claim 5, wherein the circuitry is further configured to convert the categorical shape labels and the categorical color labels into a natural-language appearance description by applying predetermined correspondence rules that map ranges of the geometric measures and the color distribution statistics to descriptive text phrases.

7. The system according to claim 6, wherein the instruction sequence is constructed by combining the natural-language appearance description with the first input data and inserting the combination into a parameterized template selected from a plurality of stored templates based on the first input data.

8. The system according to claim 1, wherein the circuitry is further configured to normalize the first input data by tokenizing text included in the first input data, mapping tokens to canonical category codes using a stored synonym mapping table, and determining at least one generalized attribute label from the canonical category codes.

9. The system according to claim 8, wherein the circuitry is further configured to select a template from a plurality of stored instruction templates based on the at least one generalized attribute label, replace variable portions in the selected template with elements derived from the canonical category codes, and output the instruction sequence as a completed natural-language string.

10. The system according to claim 9, wherein the circuitry is further configured to transmit the instruction sequence to the generative neural network model comprising a transformer-based architecture including a plurality of self-attention layers and feed-forward sublayers, and receive the generated text data as a sequence of decoded tokens.

11. The system according to claim 10, wherein the circuitry is further configured to parse the generated text data by detecting list structures and section delimiters within the generated text data, segmenting the generated text data into a plurality of item descriptions, and extracting structured attribute fields from each item description to generate structured proposal records stored in the storage device.

12. The system according to claim 11, wherein the circuitry is further configured to construct a second instruction sequence incorporating at least a portion of the structured proposal records and at least a portion of the feature vector, transmit the second instruction sequence to the generative neural network model, and acquire second generated text data describing output recommendations associated with the feature vector and the structured proposal records.

13. The system according to claim 1, wherein the circuitry is further configured to receive, from the terminal device via the communication interface, update condition data indicating refinement parameters, and generate an updated instruction sequence incorporating the refinement parameters and at least a portion of previously stored structured data associated with the generated text data.

14. The system according to claim 13, wherein the circuitry is further configured to transmit the updated instruction sequence to the generative neural network model, acquire updated generated text data, parse the updated generated text data to extract updated structured attribute data, and replace or augment the previously stored structured data with the updated structured attribute data.

15. The system according to claim 14, wherein the circuitry is further configured to transmit updated response data comprising the updated structured attribute data to the terminal device, the updated response data including a mapping between region identifiers derived from the feature vector and corresponding segments of the updated structured attribute data.

16. The system according to claim 15, wherein the terminal device renders the updated response data by overlaying the corresponding segments proximate to associated regions on the image data displayed on a display of the terminal device.

17. The system according to claim 1, wherein the first input data comprises user preference information indicating a fashion style, the set of item records comprises clothing information including at least item type, color, and style category, the second output data comprises makeup method proposal information specifying cosmetic application methods for facial regions, and the generated text data comprises a style proposal describing coordinated clothing and accessory combinations.

18. A system comprising:
circuitry configured to:
receive, via a communication interface coupled to a packet-switched network, first input data including style preference information and image data including a face image from a terminal device;
search, based on the style preference information, a storage device to retrieve a set of item records matching the style preference information;
process the face image through a convolutional neural network model comprising a plurality of convolutional layers and at least one fully connected layer to generate a feature vector comprising facial landmark coordinates, shape classification scores, and color distribution values;
generate, based on the feature vector and the set of item records, region-specific output data associating facial region identifiers derived from the facial landmark coordinates with corresponding recommendation segments;
construct, based on the style preference information and the feature vector, an instruction sequence for a transformer-based generative neural network model by inserting normalized attribute labels and a natural-language appearance description derived from the feature vector into a parameterized template, transmit the instruction sequence to the transformer-based generative neural network model, and acquire generated text data comprising structured proposal descriptions responsive to the instruction sequence; and
transmit response data comprising the generated text data and the region-specific output data to the terminal device via the communication interface.

19. The system according to claim 18, wherein the circuitry is further configured to receive update condition data from the terminal device, generate an updated instruction sequence incorporating the update condition data and at least a portion of the structured proposal descriptions, transmit the updated instruction sequence to the transformer-based generative neural network model, and acquire updated generated text data for transmission to the terminal device.

20. A method performed by circuitry of a system, the method comprising:
receiving, via a communication interface coupled to a packet-switched network, first input data and image data from a terminal device;
searching, based on the first input data, a storage device to retrieve a set of item records matching the first input data;
processing the image data through a trained neural network model to generate a feature vector representing a plurality of attributes extracted from the image data;
generating, based on the feature vector and the set of item records, second output data associated with the set of item records;
constructing, based on at least the first input data, an instruction sequence for a generative neural network model, transmitting the instruction sequence to the generative neural network model, and acquiring generated text data responsive to the instruction sequence; and
transmitting response data comprising the generated text data and the second output data to the terminal device via the communication interface.
